(19) United States
(12) Patent Application Publication
(10) Pub. No.: US 2026/0303271 A1
(43) Pub. Date: Oct. 1, 2026

(54) CHANNEL ESTIMATION BASED ON TIME DOMAIN SIGNALS

(71) Applicant: QUALCOMM Incorporated, San Diego, CA (US)

(72) Inventors: Akansh JAIN, Chennai (IN); G SRIRAM, Karaikudi (IN); Xiaoxin ZHANG, Sunnyvale, CA (US)

(21) Appl. No.: 19/090,108

(22) Filed: Mar. 25, 2025

(51) Int. Cl. H04L 5/00; H04L 25/02; H04L 27/26

(52) U.S. Cl. CPC H04L 5/0005; H04L 25/0202; H04L 27/2628

(57) ABSTRACT

Techniques for wireless communications are described. A first wireless device may receive a reference signal via a communication channel. The first wireless device may determine, within a time domain, a second set of samples, based on a first set of samples of the reference signal, including a combination of samples, at an interval in the time domain, of the first set of samples, where a quantity of the second set of samples is less than a quantity of the first set of samples Further, the first wireless device may transform the second set of samples into a frequency domain based at least in part on the second quantity of the second set of samples. The first wireless device may then perform one or more operations utilizing a channel estimation that is based at least in part on the second set of samples transformed to the frequency domain.

### FIELD OF TECHNOLOGY

The following relates to wireless communications, including channel estimation based on time domain signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first wireless device is described. The method may include receiving a reference signal from a second wireless device via a communication channel between the first wireless device and the second wireless device, determining, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples, transforming the second set of multiple samples from the time domain to a frequency domain based on the second quantity of the second set of multiple samples, and performing one or more operations utilizing a channel estimation that is based on the second set of multiple samples transformed to the frequency domain.

A first wireless device for wireless communications is described. The first wireless device may include one or more transceivers, one or more memory, and one or more processors electronically coupled to the one or more memory and the one or more transceivers. The one or more processors may be configured to receive a reference signal from a second wireless device via a communication channel between the first wireless device and the second wireless device, determine, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples, transform the second set of multiple samples from the time domain to a frequency domain based on the second quantity of the second set of multiple samples, and perform one or more operations utilizing a channel estimation that is based on the second set of multiple samples transformed to the frequency domain.

Another first wireless device for wireless communications is described. The first wireless device may include means for receiving a reference signal from a second wireless device via a communication channel between the first wireless device and the second wireless device, means for determining, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples, means for transforming the second set of multiple samples from the time domain to a frequency domain based on the second quantity of the second set of multiple samples, and means for performing one or more operations utilizing a channel estimation that is based on the second set of multiple samples transformed to the frequency domain.

A non-transitory computer-readable medium storing code for wireless communications is described. The code may include instructions executable by one or more processors to receive a reference signal from a second wireless device via a communication channel between the first wireless device and the second wireless device, determine, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples, transform the second set of multiple samples from the time domain to a frequency domain based on the second quantity of the second set of multiple samples, and perform one or more operations utilizing a channel estimation that is based on the second set of multiple samples transformed to the frequency domain.

Some examples of the method, first wireless devices, and non-transitory computer-readable medium described herein may further include operations, features, means, or instructions for estimating a difference between the second set of multiple samples in the frequency domain and reference signal information to obtain the channel estimation of the communication channel between the first wireless device and the second wireless device, where performing the one or more operations utilizing the channel estimation may be based on obtaining the channel estimation.

In some examples of the method, first wireless devices, and non-transitory computer-readable medium described herein, transforming the second set of multiple samples may include operations, features, means, or instructions for performing a fast Fourier transform (FFT) on the second set of multiple samples to transform the second set of multiple samples from the time domain to the frequency domain.

In some examples of the method, first wireless devices, and non-transitory computer-readable medium described herein, the fast Fourier transform may be an N-point FFT that may be based on the interval in the time domain.

Some examples of the method, first wireless devices, and non-transitory computer-readable medium described herein may further include operations, features, means, or instructions for communicating an indication of a factor with the second wireless device, where the reference signal may be based on an inverse fast Fourier transform (IFFT) at the second wireless device, where a size of the N-point FFT may be an integer divisor of a size of the IFFT that may be based on the factor.

In some examples of the method, first wireless devices, and non-transitory computer-readable medium described herein, the second quantity of the second set of multiple samples may be based on the interval in the time domain.

In some examples of the method, first wireless devices, and non-transitory computer-readable medium described herein, the reference signal may be associated with a multi-stream communication.

In some examples of the method, first wireless devices, and non-transitory computer-readable medium described herein, determining the second set of multiple samples may be based on a processing procedure before transforming the second set of multiple samples from the time domain to the frequency domain.

In some examples of the method, first wireless devices, and non-transitory computer-readable medium described herein, the one or more operations utilizing the channel estimation may be associated with channel positioning procedures, channel sensing procedures, channel sounding procedures, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports channel estimation based on time domain signals in accordance with one or more aspects of the present disclosure.

FIG. 2 shows an example of a wireless network structure that supports channel estimation based on time domain signals in accordance with one or more aspects of the present disclosure.

FIG. 3 shows an example of a network architecture that supports channel estimation based on time domain signals in accordance with one or more aspects of the present disclosure.

FIGS. 4 and 5 show examples of wireless communications systems that support channel estimation based on time domain signals in accordance with one or more aspects of the present disclosure.

FIG. 6 shows an example of a process flow that supports channel estimation based on time domain signals in accordance with one or more aspects of the present disclosure.

FIGS. 7 and 8 show block diagrams of devices that support channel estimation based on time domain signals in accordance with one or more aspects of the present disclosure.

FIG. 9 shows a block diagram of a communications manager that supports channel estimation based on time domain signals in accordance with one or more aspects of the present disclosure.

FIG. 10 shows a diagram of a system including a device that supports channel estimation based on time domain signals in accordance with one or more aspects of the present disclosure.

FIGS. 11 and 12 show flowcharts illustrating methods that support channel estimation based on time domain signals in accordance with one or more aspects of the present disclosure.

FIG. 13 shows examples of wireless communications systems that support channel estimation based on time domain signals in accordance with one or more aspects of the present disclosure.

FIG. 14 shows examples of sensing modes that support channel estimation based on time domain signals in accordance with one or more aspects of the present disclosure.

### DETAILED DESCRIPTION

In some wireless communication systems, chipsets may be used in low-power devices such as wearables and Internet of Things (IoT) devices. In some cases, low-power and low-cost chipsets may be used for one or more location, sensing, or sounding procedures. Further, to perform one or more location, sensing, or sounding procedures, wireless devices may determine (e.g., obtain or calculate) a channel estimation. In some examples, when performing channel estimation, a receiver may demodulate a packet (e.g., a reference signal) and estimate a channel response for each tone in the frequency domain. However, for location, sensing, and sounding, the wireless device may be capable of using a subset of the tones to perform channel estimation. For example, wide bandwidth channel estimates may be relatively complex and expensive to generate and may be unnecessary for a location, sensing, or sounding procedure. Thus, in some examples, a wireless device may determine a channel estimation by decimating tones or removing tones to reduce the quantity of tones used for determining channel estimations. Such channel estimations determined from subsets of tones may be relatively efficient for location, sensing, and sounding procedures and may have a relatively minimal performance loss. However, generating a channel estimation by receiving a reference signal in the time domain, performing a transformation procedure to convert the reference signal into the frequency domain, and then decimating tones in the frequency domain may be relatively complex and may consume a relatively large quantity of power for low-power devices used for location, sensing, and sounding. Thus, low-power devices may be unable to perform such procedures as they can result in an increase in delay of communications and a decrease in reliability of a wireless communication system.

In accordance with some of the techniques of the present disclosure a wireless device may utilize a relatively smaller transformation procedure on a signal that is processed in the time-domain to reduce the cost, complexity, and power consumption of a receiver. To utilize the relatively smaller transformation procedure, after receiving a reference signal, the wireless device may combine multiple samples of the reference signal in the time domain to generate a reduced quantity of samples of the reference signal. For example, the wireless device may sum two or more of a first set of samples of a reference signal, at an interval, to generate a second set of samples with relatively fewer samples than the first set of samples. Further, by reducing the quantity of samples, the transformation procedure used to convert the reference signal into the frequency domain may be of a smaller size than an inverse transformation procedure used for transmission of the reference signal to the wireless device. Moreover, by reducing the transformation procedure size, the overall complexity of the receiver at the wireless device may be reduced thus reducing the cost and power consumption of the receiver. After the transformation procedure, the receiver of the wireless device may directly remove the reference signal to obtain the channel estimate without performing any decimation procedure, thus further reducing the overall complexity, latency, and power consumption associated with obtaining the channel estimate. Thus, the techniques of the present disclosure may result in techniques for obtaining a channel estimate by pre-processing a reference signal prior to performing a transformation procedure such to prevent utilization of a decimation procedure and ensuring relatively minimal to no loss in performance and accuracy of the channel estimate.

Aspects of the disclosure are initially described in the context of wireless communications systems. Aspects of the disclosure are also described in the context of a wireless network structure. Aspects of the disclosure are further described in the context of a network architecture. Aspects of the disclosure are additionally described in the context of process flows. Aspects of the disclosure are further illustrated by and described with reference to apparatus diagrams, system diagrams, and flowcharts that relate to channel estimation based on time domain signals.

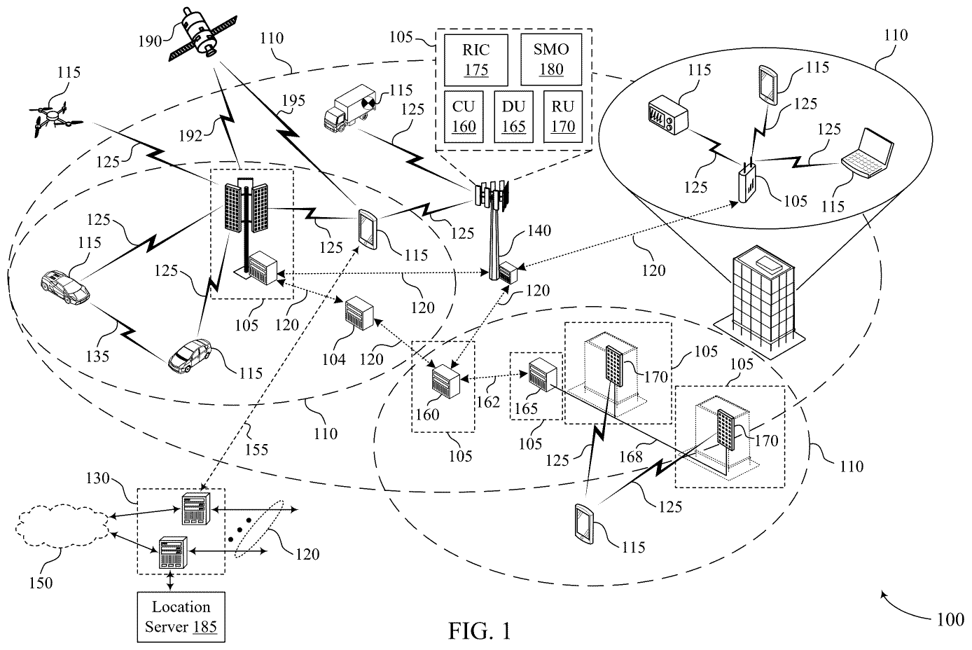

FIG. 1 shows an example of a wireless communications system 100 that supports channel estimation based on time domain signals in accordance with one or more aspects of the present disclosure. The wireless communications system 100 may include one or more devices, such as one or more network devices (e.g., network entities or network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The wireless communications system 100 may include one or more devices, such as one or more network devices (e.g., network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a network entity, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or have different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network entity or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be another UE 115. In another aspect of this example, the first node may be a UE 115, the second node may be a network node 105, and the third node may be another network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via wired or wireless backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point (AP), a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network entities (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a TRP. One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1 interface, F1-c interface, or F1-u, among other examples), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support testing as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network entities, such as one or more of the network nodes 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network entities (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may support synchronous or asynchronous operation. For synchronous operation, network nodes 105 (e.g., base stations 140) may have similar frame timings, and transmissions from different network entities (e.g., different ones of the network nodes 105) may be approximately aligned in time. For asynchronous operation, network nodes 105 may have different frame timings, and transmissions from different network entities (e.g., different ones of network nodes 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network entities (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may include an location server 185 (e.g., LMF). The location server 185 may provide positioning, location, or tracking functions. For instance, the location server 185 may participate in one or more positioning procedures to determine a location of (e.g., coordinates of, relative distance(s) to, or an address of) one or more of the UEs 115. Examples of positioning procedures may include one or more operations of assisted global navigation satellite system (A-GNSS), observed time difference of arrival (OTDOA), enhanced cell identifier (E-CID), sensor-based positioning, wireless local area network (WLAN)-based positioning, Bluetooth-based positioning, terrestrial beacon systems (TBS) positioning, downlink time difference of arrival (DL-TDOA), downlink angle of departure (DL-AOD), multi-round-trip time (Multi-RTT), New Radio enhanced cell identifier (NR E-CID), uplink time difference of arrival (UL-TDOA), and uplink angle of arrival (UL-AOA), among other examples. Some examples of the positioning procedures may be managed by, assisted by, or performed with the location server 185. For instance, measurements associated with reference signaling may be provided to the location server 185, which may estimate a location of a UE 115 based on the measurements. In some aspects, the location server 185 may track or store location information corresponding to one or more UEs 115. Some examples of the positioning procedures may be performed without the location server 185.

The location server 185 may be included in the core network 130 or may be separate from the core network 130. In some examples, a location server 185 may be a standalone device or may be included in (e.g., integrated with) a network node 105, a base station 140, a UE 115, a satellite 190, a server, or another device. For instance, the location server 185 may be (or may be included in) a secure user plane location (SUPL) location platform (SLP) device, a third-party server, or another device. The location server 185 may generally refer to a positioning device, a location device, a computing device, or a server, among other examples.

A UE 115 may communicate with the location server 185 directly or indirectly. For example, a UE 115 may communicate with the location server 185 via a network node 105 that is serving the UE 115 and via the core network 130. Additionally, or alternatively, a UE 115 may communicate with the location server 185 through another path (e.g., via an application server (not shown)) or via another network (e.g., via a WLAN AP), among other examples. Communication between a UE 115 and the location server 185 may be represented via an indirect connection (e.g., through a communication link 125, a network node 105, a communication link 155, a backhaul communication link 120, or the core network 130) or as a direct connection, with one or more intervening nodes (if any) omitted for concision or convenience.

A satellite 190 may be an aerial or space vehicle with signaling capability. In some examples, the wireless communications system 100 may include or communicate with one or more satellites 190. The satellite(s) 190 may be included in one or more satellite positioning systems (e.g., GNSS(s)). A satellite positioning system may include any combination of one or more global or regional navigation satellites associated with one or more satellite positioning systems (e.g., global positioning system (GPS), global navigation satellite system (GLONASS), BeiDou navigation satellite system (BDS), or Galileo, among other examples). A satellite positioning system may include satellites 190 or other transmitters positioned to enable receivers (e.g., UEs 115) to determine a location on or above the Earth based on signals (e.g., the signals 195) received from the satellites 190. For instance, each satellite 190 may transmit a signal 195 marked with a repeating pseudo-random noise (PN) code of a set quantity of chips. In some cases, one or more transmitters located on ground-based control stations, network nodes 105, or UEs 115 may transmit signals for enabling a UE 115 to determine a location.

A UE 115 may include one or more receivers designed to receive the signal(s) 195 from the satellite(s) 190 for determining location information (e.g., a geographic location of the UE 115). For instance, the UE 115 may receive one or more signals 195 from the satellite(s) 190, which may be utilized to determine a location of the UE 115.

In a satellite positioning system, the use of signals 195 may be augmented with one or more satellite-based augmentation systems (SBAS) that may be associated with or enabled for use with one or more global or regional navigation satellite systems. An SBAS may provide integrity information, differential corrections, or other information for use in conjunction with a satellite positioning system. An SBAS may include one or more augmentation systems, such as the Wide Area Augmentation System (WAAS), the European Geostationary Navigation Overlay Service (EGNOS), the Multi-functional Satellite Augmentation System (MSAS), or the GPS Aided Geo Augmented Navigation (GAGAN) system, among other examples.

In some aspects, the satellite(s) 190 may be included in one or more non-terrestrial networks (NTNs). In an NTN, a satellite 190 may communicate with one or more devices (e.g., network entities, ground stations, NTN gateways, or gateways) located on or above the Earth. For example, the satellite 190 may send or receive one or more communications 192 with a network node 105. In some aspects, the communication(s) 192 may include one or more signals relayed to or from a UE 115. Additionally, or alternatively, the satellite 190 may communicate with another terrestrial device that is connected to one or more elements of the wireless communications system 100. For instance, the satellite 190 may communicate with a ground station or NTN gateway, which may provide access to the wireless communications system 100 or one or more other entities (e.g., Internet web servers or one or more other user devices) external to the wireless communications system 100. In some examples, a UE 115 may receive communication signals 195 from the satellite 190 instead of, or in addition to, communication signals from a terrestrial network entity.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize licensed or unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, chipsets may be used in low-power devices such as wearables and IoT devices. In some cases, such low-power and low-cost chipsets may be used for location, sensing, and sounding procedures that can include determining channel estimations. In some examples, when performing channel estimation, a receiver of a wireless device (e.g., a UE 115) may demodulate a packet (e.g., a reference signal) and estimate a channel response for each tone in the frequency domain. However, for location, sensing, and sounding, the wireless device may be capable of using a subset of the tones to perform channel estimation. However, channel estimation procedures that include a decimation procedure may be relatively complex and may consume a relatively large quantity of power for low-power devices used for location, sensing, and sounding. Thus, low-power devices may be unable to perform such procedures as they can result in an increase in delay of communications and a decrease in reliability of a wireless communication system.

In accordance with some of the techniques of the present disclosure, a wireless device may perform a relatively smaller transformation procedure on a signal that is pre-processed in the time-domain to reduce the cost, complexity, and power consumption of a receiver. To perform the relatively smaller transformation procedure, after receiving a reference signal, the wireless device may combine multiple samples of the reference signal in the time domain to generate a reduced quantity of samples of the reference signal. For example, the wireless device may sum two or more of a first set of samples at an interval to generate a second set of samples with fewer samples than the first set of samples. Further, by reducing the quantity of samples, the transformation procedure used to convert the reference signal into the frequency domain may be of a smaller size than a transformation procedure used for generation and transmission of the reference signal to the wireless device. Moreover, by reducing the size of the transformation procedure, the overall complexity of the receiver at the wireless device may be reduced thus reducing the cost and power consumption of the receiver. After the transformation procedure, the receiver of the wireless device may directly remove the reference signal to obtain the channel estimate without performing any decimation procedure, thus further reducing the overall complexity, latency, and power consumption associated with obtaining the channel estimate. Therefore, by pre-processing a reference signal, in accordance with the techniques of the present disclosure, prior to performing a transformation procedure for obtaining a channel estimate as to prevent utilization of a decimation procedure, wireless devices may ensure relatively minimal to no loss in performance and accuracy of the channel estimate.

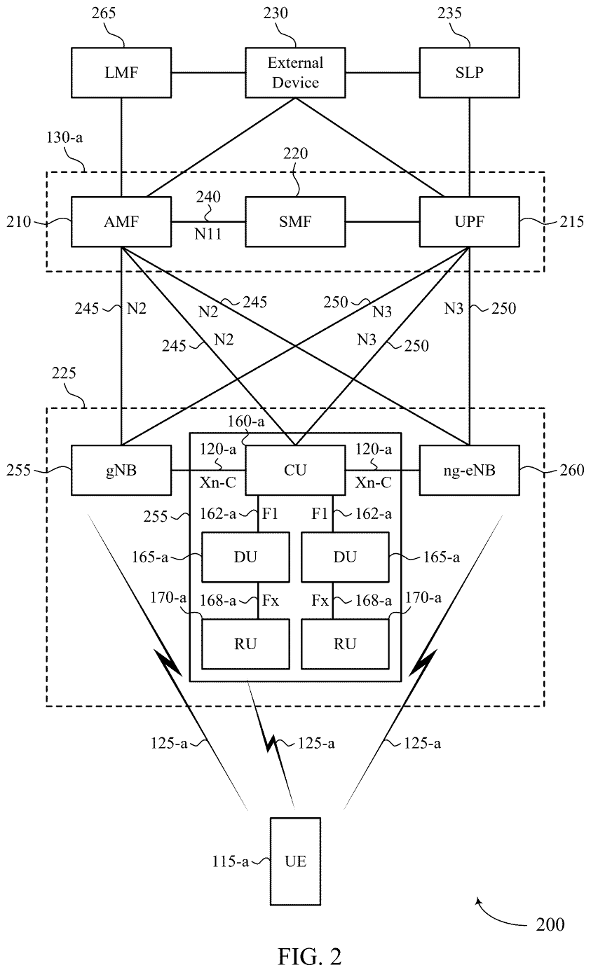

FIG. 2 shows an example of a wireless network structure 200 that supports channel estimation based on time domain signals in accordance with one or more aspects of the present disclosure. The wireless network structure 200 may include a core network 130-a, a RAN 225, a UE 115-a, an LMF 265, an external device 230 (e.g., third-party device or server), or an SLP 235. In some examples, the wireless network structure 200 may be included in the wireless communications system 100 described with reference to FIG. 1. The core network 130-a may be an example of the core network 130, the UE 115-a may be an example of the UEs 115, or the LMF 265 may be an example of the location server 185, as described with reference to FIG. 1.

The core network 130-a may provide one or more control plane (C-plane) functions (e.g., UE registration, authentication, network access, or gateway selection, among other examples) or one or more user plane (U-plane) functions (e.g., UE gateway function, data network access, or IP routing, among other examples). One or more of the functions of the core network 130-a may be implemented in one or more devices (e.g., one or more electronic devices, computing devices, servers, among other examples) in hardware (e.g., circuitry) or a combination of hardware and instructions (e.g., a processor with instructions). The core network 130-a may be an EPC, 5GC, or a Next Generation Core (NGC), among other examples.

The core network 130-a may provide an AMF 210, a session management function (SMF) 220, or a user plane function (UPF) 215. The AMF 210 may provide one or more C-plane functions, such as registration management, connection management, reachability management, mobility management, lawful interception, transport for session management (SM) messages between one or more UEs 115-a and the SMF 220, transparent proxy services for routing SM messages, access authentication and access authorization, transport for short message service (SMS) messages between the UE 115-a and the short message service function (SMSF), or security anchor functionality (SEAF), among other examples. In some aspects, the AMF 210 may interact with an authentication server function (AUSF) and the UE 115-a, and may receive an intermediate key established as a result of a UE 115-a authentication process. In a case of authentication based on a universal mobile telecommunications system (UMTS) subscriber identity module (USIM), the AMF 210 may retrieve security information from the AUSF. In some examples, the AMF 210 may provide a security context management (SCM) function. The SCM function may receive a key from the SEAF that may be utilized to derive access-network specific keys. The AMF 210 may provide location services management for regulatory services, transport for location services messages between the UE 115-a and an LMF 265, transport for location services messages between the RAN 225 and the LMF 265, evolved packet system (EPS) bearer identifier allocation for interworking with the EPS, or UE 115-a mobility event notification. In some approaches, the AMF 210 may support one or more functionalities for Third Generation Partnership Project (3GPP) access networks or non-3GPP access networks.

The UPF 215 may provide one or more U-plane functions, such as acting as an anchor point for intra/inter-RAT mobility, acting as an external protocol data unit (PDU) session point of interconnection to a data network, providing packet routing and forwarding, packet inspection, user plane policy rule enforcement (e.g., gating, redirection, or traffic steering), user plane collection (e.g., interception), traffic usage reporting, quality of service (QoS) handling for the U-plane (e.g., uplink or downlink rate enforcement, reflective QoS marking in the downlink), uplink traffic verification (e.g., service data flow (SDF) to QoS flow mapping), transport level packet marking in the uplink or downlink, downlink packet buffering, downlink data notification triggering, or sending or forwarding one or more indications of an end of a transmission (e.g., “end markers”) to a source RAN node, among other examples. In some examples, the UPF 215 may support the transfer of location services messages over a U-plane between the UE 115-a and another device (e.g., the SLP 235 or the external device 230.

The SMF 220 may provide one or more functions, such as session management, UE IP address allocation and management, selection and control of user plane functions, configuration of traffic steering at the UPF 215 to route traffic to a destination, control (e.g., partial control) of policy enforcement or QoS, or downlink data notification. In some aspects, the SMF 220 may communicate with the AMF 210 over an N11 interface 240.

The RAN 225 may include one or more gNBs 255 or one or more ng-eNBs 260. The gNB(s) 255 or the ng-eNB(s) 260 may be examples of the network nodes 105 described with reference to FIG. 1. For instance, a next generation RAN (NG-RAN) may include one or more gNBs 255, or other examples of the RAN 225 may include one or more ng-eNBs 260 or gNBs 255.

The core network 130-a may communicate with the RAN 225 via a C-plane interface 245 (e.g., NG-C or N2 interface) or a U-plane interface 250 (e.g., NG-U or N3 interface). The C-plane interface 245 or the U-plane interface 250 may connect the gNB 255 or the ng-eNB 260 to the core network 130-a (e.g., to one or more control plane functions or one or more user plane functions). For instance, the C-plane interface 245 may connect the AMF 210 to one or more gNBs 255 or ng-eNBs 260 in the RAN 225, or the U-plane interface 250 may connect the UPF 215 to one or more gNBs 255 or ng-eNBs 260 in the RAN 225. The gNB(s) 255 or ng-eNB(s) 260 of the RAN 225 may communicate with each other via one or more backhaul communication links 120-a (e.g., Xn-C interface). The backhaul communication link(s) 120-a may be examples of the backhaul communication links 120 described with reference to FIG. 1. One or more of the gNBs 255 or ng-eNBs 260 may communicate with one or more UEs 115-a over one or more communication links 125-a (e.g., the Uu interface). The communication link(s) 125-a may be examples of the communication links 125 described with reference to FIG. 1.

The LMF 265 may communicate with the core network 130-a to provide location functionality (e.g., to participate in one or more positioning procedures) for the UE(s) 115-a. The LMF 265 may be an example of the location server 185 described with reference to FIG. 1. The LMF 265 may be implemented as one or more devices (e.g., one or more servers, such as physically separate servers, one or more instruction sets on a single server, or instruction sets distributed across multiple physical servers, among other examples). The LMF 265 may support one or more location services for one or more UEs 115-a that may connect to the LMF 265 via the RAN 225, via the core network 130-a, or via another connection (e.g., the Internet). In some examples, the LMF 265 may communicate with a UE 115-a or another device via a C-plane connection (e.g., using one or more interfaces or protocols for signaling control information, or separate from voice or payload data). In some aspects, the LMF 265 may be integrated into a component of the core network 130-a or may be external to the core network 130-a (e.g., on an external device 230, such as an original equipment manufacturer (OEM) server or other server).

In some examples, the SLP 235 may provide location functionality (e.g., may participate in one or more positioning procedures) for the UE(s) 115-a. The SLP 235 may be an example of the location server 185 described with reference to FIG. 1. The SLP 235 may be implemented as one or more devices (e.g., one or more servers, such as physically separate servers, one or more instruction sets on a single server, or instruction sets distributed across multiple physical servers, among other examples). The SLP 235 may support one or more location services for one or more UEs 115-a that may connect to the SLP 235 via the RAN 225, via the core network 130-a, or via another connection (e.g., the Internet). In some examples, the SLP 235 may communicate with a UE 115-a or another device via a U-plane connection (e.g., using one or more interfaces or protocols for signaling voice or payload data, such as a transmission control protocol (TCP) or IP).

In some examples, the external device 230 may communicate with the LMF 265, the SLP 235, the core network 130-a (e.g., via the AMF 210 or the UPF 215), the RAN 225, or the UE 115-a to obtain location information (e.g., a location estimate) for the UE 115-a. The external device 230 may be referred to as a location services (LCS) client or an external client. The external device 230 may be implemented as one or more devices (e.g., one or more servers, such as physically separate servers, one or more instruction sets on a single server, or instruction sets distributed across multiple physical servers, among other examples). The external device 230 may support one or more location services for one or more UEs 115-a that may connect to the external device 230 via the RAN 225, via the core network 130-a, or via another connection (e.g., the Internet).

In some approaches, the functionality of a gNB 255 may be divided between a CU 160-a, one or more DUs 165-a, or one or more RUs 170-a. The CU 160-a may be an example of the CU 160 described with reference to FIG. 1, the one or more DUs 165-a may be examples of the DU 165 described with reference to FIG. 1, or the one or more RUs 170-a may be examples of the RU 170 described with reference to FIG. 1. In some examples, the CU 160-a may provide one or more functions, such as transferring user data, mobility control, radio access network sharing, positioning, session management, or others, except for one or more functions allocated exclusively to the DU(s) 165-a. A DU 165-a may support one or more cells. The DUs 165-a may communicate with the CU 160-a via midhaul communication links 162-a (e.g., via the F1 interface). The midhaul communication links 162-a may be examples of the midhaul communication links 162 described with reference to FIG. 1. The RUs 170-a may perform one or more functions such as power amplification, signal transmission, or signal reception. The RUs 170-a may communicate with the DUs 165-a via fronthaul communication links 168-a (e.g., via the Fx interface). The fronthaul communication links 168-a may be examples of the fronthaul communication links 168 described with reference to FIG. 1. The UE 115-a may communicate with the gNB 255, RU 170-a, or ng-eNB 260 a via communication links 125-a. The communication links 125-a may be examples of the communication links 125 described with reference to FIG. 1. The UE 115-a may communicate with the CU 160-a via the RRC, SDAP, and PDCP layers, with a DU 165-a via the RLC and MAC layers, or with an RU 170-a via the PHY layer.

In some examples of the wireless network structure 200, low-power devices (e.g., the UE 115-a) may be used for location, sensing, and sounding procedures. Further, to perform location, sensing, and sounding procedures, wireless devices (e.g., the UE 115-a) may determine (e.g., obtain or calculate) a channel estimation. In some examples, when performing channel estimation, a receiver may demodulate a packet (e.g., a reference signal) from a second wireless device (e.g., an LMF 265, a network node 105, or any combination thereof) and estimate a channel response for each tone in the frequency domain. In some aspects, to reduce the complexity of channel estimation, a wireless device may determine a channel estimation by decimating tones or removing tones to reduce the quantity of tones used for determining channel estimations. However, such channel estimation procedures may be relatively complex and may consume a relatively large quantity of power for low-power devices used for location, sensing, and sounding. Thus, low-power devices may be unable to perform such procedures as they can result in an increase in delay of communications and a decrease in reliability of a wireless communication system.

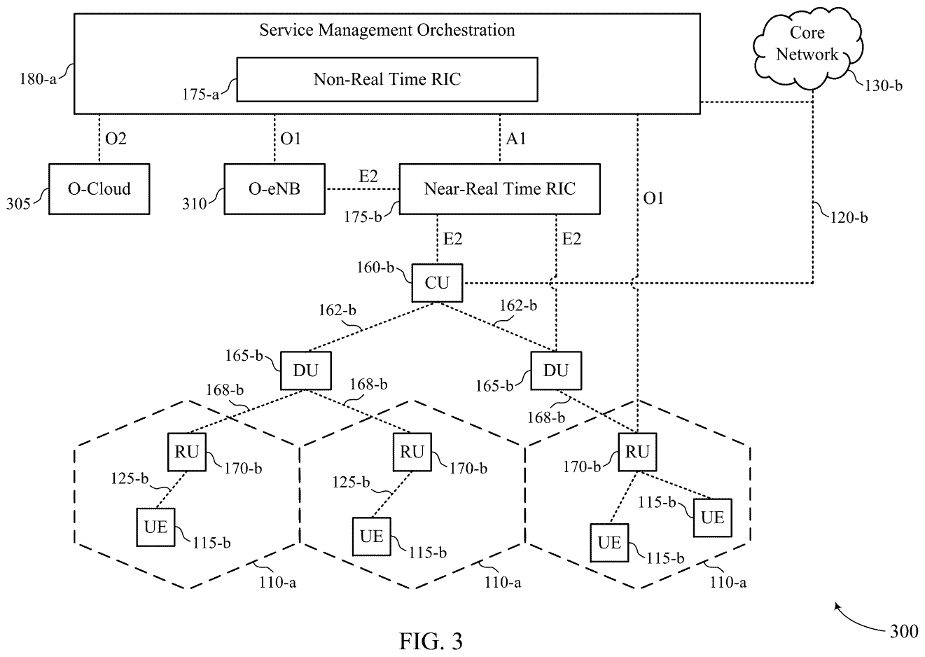

In accordance with some of the techniques of the present disclosure a wireless device may perform a relatively smaller transformation procedure on a signal that is pre-processed in the time-domain to reduce the cost, complexity, and power consumption of a receiver. To perform the relatively smaller transformation procedure, after receiving a reference signal, the wireless device may combine multiple samples of the reference signal in the time domain to generate a reduced quantity of samples of the reference signal. By reducing the quantity of samples, the transformation procedure used to convert the reference signal into the frequency domain may be of a smaller size than a transformation procedure used by a second wireless device (e.g., an LMF 265, a network node 105, or any combination thereof) for generation and transmission of the reference signal to the wireless device, which can result in a reduction of the cost and power consumption of the receiver. Therefore, by pre-processing a reference signal, in accordance with the techniques of the present disclosure, prior to performing a transformation procedure for obtaining a channel estimate as to prevent utilization of a decimation procedure, wireless devices may ensure relatively minimal to no loss in performance and accuracy of the channel estimate. Further descriptions of the techniques of the present disclosure such as the pre-processing procedure may be described elsewhere herein, such as with reference to FIGS. 3 through 5.

FIG. 3 shows an example of a network architecture 300 (e.g., a disaggregated base station architecture, a disaggregated RAN architecture) that supports channel estimation based on time domain signals in accordance with one or more aspects of the present disclosure. The network architecture 300 may illustrate an example for implementing one or more aspects of the wireless communications system 100. The network architecture 300 may include one or more CUs 160-b that may communicate directly with a core network 130-b via a backhaul communication link 120-b, or indirectly with the core network 130-b through one or more disaggregated network nodes 105 (e.g., a Near-RT RIC 175-b via an E2 link, or a Non-RT RIC 175-a associated with an SMO 180-a (e.g., an SMO Framework), or both). A CU 160-b may communicate with one or more DUs 165-b via respective midhaul communication links 162-b (e.g., an F1 interface). The DUs 165-b may communicate with one or more RUs 170-b via respective fronthaul communication links 168-b. The RUs 170-b may be associated with respective coverage areas 110-a and may communicate with UEs 115-b via one or more communication links 125-b. In some implementations, a UE 115-b may be simultaneously served by multiple RUs 170-b.

Each of the network nodes 105 of the network architecture 300 (e.g., CUs 160-b, DUs 165-b, RUs 170-b, Non-RT RICs 175-a, Near-RT RICs 175-b, SMOs 180-a, Open Clouds (O-Clouds) 305, Open eNBs (O-eNBs) 310) may include one or more interfaces or may be coupled with one or more interfaces configured to receive or transmit signals (e.g., data, information) via a wired or wireless transmission medium. Each network node 105, or an associated processor (e.g., controller) providing instructions to an interface of the network node 105, may be configured to communicate with one or more of the other network nodes 105 via the transmission medium. For example, the network nodes 105 may include a wired interface configured to receive or transmit signals over a wired transmission medium to one or more of the other network nodes 105. Additionally, or alternatively, the network nodes 105 may include a wireless interface, which may include a receiver, a transmitter, or transceiver (e.g., an RF transceiver) configured to receive or transmit signals, or both, over a wireless transmission medium to one or more of the other network nodes 105.

In some examples, a CU 160-b may host one or more higher layer control functions. Such control functions may include RRC, PDCP, SDAP, or the like. Each control function may be implemented with an interface configured to communicate signals with other control functions hosted by the CU 160-b. A CU 160-b may be configured to handle user plane functionality (e.g., CU-UP), control plane functionality (e.g., CU-CP), or a combination thereof. In some examples, a CU 160-b may be logically split into one or more CU-UP units and one or more CU-CP units. A CU-UP unit may communicate bidirectionally with the CU-CP unit via an interface, such as an E1 interface when implemented in an O-RAN configuration. A CU 160-b may be implemented to communicate with a DU 165-b, as necessary, for network control and signaling.

A DU 165-b may correspond to a logical unit that includes one or more functions (e.g., base station functions, RAN functions) to control the operation of one or more RUs 170-b. In some examples, a DU 165-b may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-b may further host one or more low PHY layers. Each layer may be implemented with an interface configured to communicate signals with other layers hosted by the DU 165-b, or with control functions hosted by a CU 160-b.

In some examples, lower-layer functionality may be implemented by one or more RUs 170-b. For example, an RU 170-b, controlled by a DU 165-b, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-b may be implemented to handle over the air (OTA) communication with one or more UEs 115-b. In some implementations, real-time and non-real-time aspects of control and user plane communication with the RU(s) 170-b may be controlled by the corresponding DU 165-b. In some examples, such a configuration may enable a DU 165-b and a CU 160-b to be implemented in a cloud-based RAN architecture, such as a vRAN architecture.

The SMO 180-a may be configured to support RAN deployment and provisioning of non-virtualized and virtualized network nodes 105. For non-virtualized network nodes 105, the SMO 180-a may be configured to support the deployment of dedicated physical resources for RAN coverage requirements which may be managed via an operations and maintenance interface (e.g., an O1 interface). For virtualized network nodes 105, the SMO 180-a may be configured to interact with a cloud computing platform (e.g., an O-Cloud 305) to perform network node life cycle management (e.g., to instantiate virtualized network nodes 105) via a cloud computing platform interface (e.g., an O2 interface). Such virtualized network nodes 105 can include, but are not limited to, CUs 160-b, DUs 165-b, RUs 170-b, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-b via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, artificial intelligence (AI) or machine learning (ML) workflows including model training and updates, or policy-based guidance of applications/features in the Near-RT RIC 175-b. The Non-RT RIC 175-a may be coupled with or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-b, one or more DUs 165-b, or both, as well as an O-eNB 310, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples of the network architecture, low-power devices (e.g., the UE 115-b) may be used for location, sensing, and sounding procedures. Further, to perform location, sensing, and sounding procedures, wireless devices (e.g., the UE 115-b) may determine (e.g., obtain or calculate) a channel estimation. In some examples, when performing channel estimation, a receiver may demodulate a packet (e.g., a reference signal) from a second wireless device (e.g., an LMF, a sensing management function (SnMF), a network node, a CU 160 b, a DU 165 b, an RU 170 b, or a combination thereof) and estimate a channel response for each tone in the frequency domain. In some aspects, to reduce the complexity of channel estimation, a wireless device may determine a channel estimation by decimating tones or removing tones to reduce the quantity of tones used for determining channel estimations. However, such channel estimation procedures may be relatively complex and may consume a relatively large quantity of power for low-power devices used for location, sensing, and sounding. Thus, low-power devices may be unable to perform such procedures as they can result in an increase in delay of communications and a decrease in reliability of a wireless communication system.

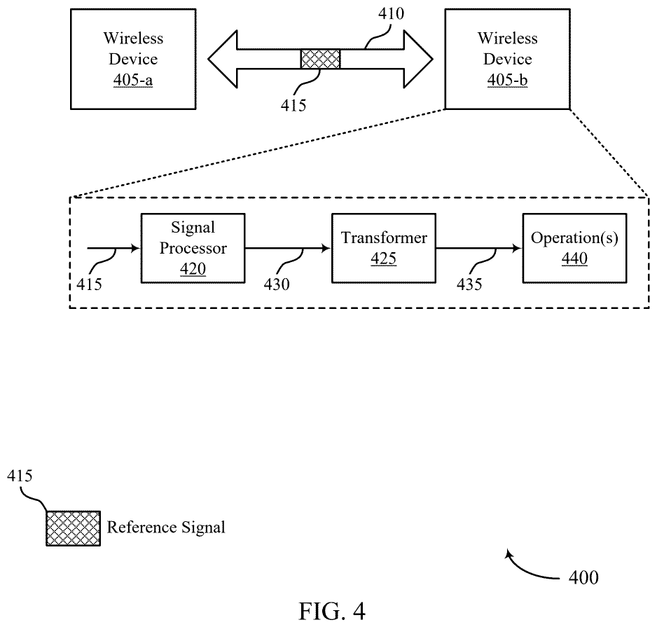

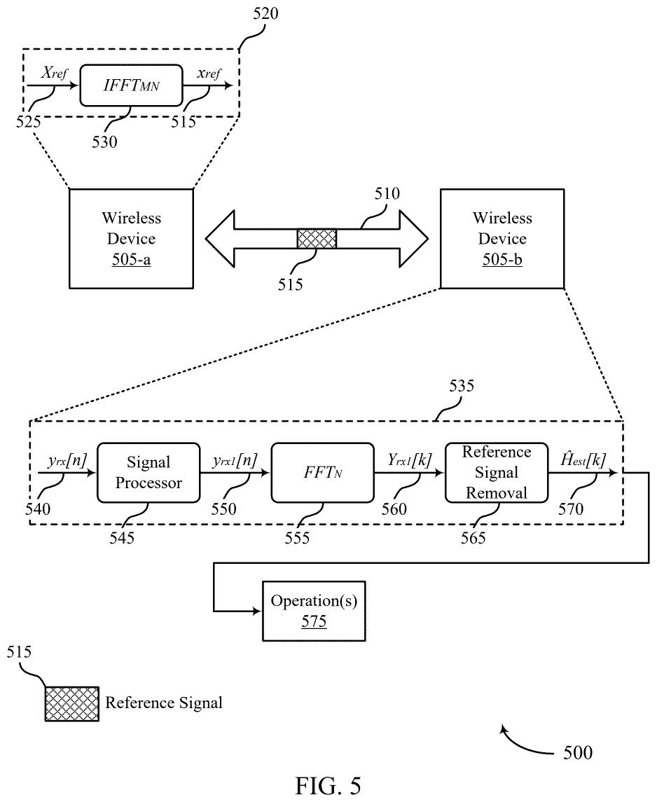

In accordance with some of the techniques of the present disclosure a wireless device may perform a relatively smaller transformation procedure on a signal that is pre-processed in the time-domain to reduce the cost, complexity, and power consumption of a receiver. To perform the relatively smaller transformation procedure, after receiving a reference signal, the wireless device may combine multiple samples of the reference signal in the time domain to generate a reduced quantity of samples of the reference signal. By reducing the quantity of samples, the transformation procedure used to convert the reference signal into the frequency domain may be of a smaller size than a transformation procedure used by a second wireless device (e.g., an LMF, a SnMF, a network node 105, a CU 160 b, a DU 165 b, an RU 170 b, or a combination thereof) for generation and transmission of the reference signal to the wireless device, which can result in a reduction of the cost and power consumption of the receiver. Therefore, by pre-processing a reference signal, in accordance with the techniques of the present disclosure, prior to performing a transformation procedure for obtaining a channel estimate as to prevent utilization of a decimation procedure, wireless devices may ensure relatively minimal to no loss in performance and accuracy of the channel estimate. Further descriptions of the techniques of the present disclosure such as the pre-processing procedure may be described elsewhere herein, such as with reference to FIGS. 4 through 5.

FIG. 4 shows an example of a wireless communications system 400 that supports channel estimation based on time domain signals in accordance with one or more aspects of the present disclosure. The wireless communications system 400 may implement aspects of or may be implemented by aspects of the wireless communications system 100. For example, the wireless communications system 400 includes a wireless device 405-a and a wireless device 405-b. In some examples, the wireless device 405-a, the wireless device 405-b, or both may be examples of a UE 115, network node 105, RU 170, DU 165, or CU 160 described with reference to FIG. 1, a UE 115-a, gNB 255, RU 170-a, DU 165-a, CU 160-a, or ng-eNB 260 described with reference to FIG. 2, or a UE 115-b, RU 170-b, DU 165-b, or CU 160-b described with reference to FIG. 3. In some other examples, the wireless device 405-a, the wireless device 405-b, or both may be examples of a network node 105, location server 185, RU 170, DU 165, or CU 160 described with reference to FIG. 1, an LMF 265, external device 230, SLP 235, AMF 210, SMF 220, UPF 215, gNB 255, RU 170-a, DU 165-a, CU 160-a, or ng-eNB 260 described with reference to FIG. 2, an RU 170-b, DU 165-b, or CU 160-b described with reference to FIG. 3, an SnMF, or another device. Further, as described herein, the wireless device 405-a may be a transmitter device and the wireless device 405-b may be a receiver device. In some aspects, the wireless device 405-a or the wireless device 405-b may be a transmitter device, a receiver device, or a combination thereof.

In some examples, the wireless device 405-a and the wireless device 405-b may communicate via a communication link 410. The communication link 410 may be an example of a Uu link, a sidelink, a backhaul link, a D2D link, or another type of communication link 125 described herein with reference to FIGS. 1-3. In some aspects, the wireless device 405-a may transmit a reference signal 415 to the wireless device 405-b via the communication link 410.

In some examples, a wireless device 405 (e.g., wireless device 405-a or wireless device 405-b) may include one or more relatively low-cost or low-power chipsets that are configured for positioning, sensing, or sounding procedures. Examples of the wireless device 405-a or the wireless device 405-b may include low-power wearable devices such as watches (e.g., smart watches), earbuds, headphones, or smart glasses, among others. Additionally, or alternatively, examples of the wireless devices 405-a or the wireless device 405-b may include relatively low-cost IoT devices. An IoT device may be a device that includes one or more sensors or other components such that the device is capable of connecting to a network (e.g., the internet) and exchanging data with one or more other devices via a wireless communication connection (e.g., the communication link 410).

In some cases, in order for a receiver (e.g., the wireless device 405-b) to demodulate a packet (e.g., a reference signal 415) properly, the wireless device 405-b may generate a channel estimation for the communication link 410. In some cases, when generating the channel estimation, the wireless device 405-b may estimate a channel response for each tone of the reference signal 415 in the frequency domain. However, estimating a channel response for each tone of the reference signal 415 may be relatively time-consuming and power-consuming due to the computational complexity. Moreover, as the wireless device 405-b may be capable of generating a relatively accurate channel estimation without each tone, the wireless device 405-b may perform a decimation procedure to generate a channel estimation.

For example, for Wi-Fi sounding, the wireless device 405-b may be capable of performing a decimation procedure (e.g., a 4x or 8x decimation procedure where every fourth or every eighth tone is decimated) when generating a sounding report. For WLAN sensing procedures, the wireless device 405-b may support a decimation procedure (e.g., a 4x, 8x, or 16x decimation procedure). For WLAN positioning procedures, the wireless device 405-b may utilize a 2x-long training field duration (2x-LTF) to perform a 2x decimation of a full 4x channel estimation. Additionally, or alternatively, other radio technologies such as Bluetooth, ultra-wideband (UWB), millimeter wave (mmWave) communications, or any combination thereof may also use one or more decimation procedures. Some positioning procedures (e.g., location procedures), sensing procedures, or sounding procedures with decimated channel estimates (e.g., channel estimates obtained in accordance with decimation procedures) may experience relatively minimal performance loss. Wide bandwidth (e.g., UWB, mmWave, or both) channel estimates may increase complexity and cost at a receiver or may be excessive for some use cases.

As positioning procedures, sensing procedures, or sounding procedures become more prevalent (e.g., ubiquitous), the demand for low-cost and low-complexity products that utilize such procedures may increase. In some cases, in OFDM systems, the wireless device 405-b may obtain a channel estimation by the wireless device 405-a transmitting an established reference signal (e.g., the reference signal 415), which may be removed by the wireless device 405-b in the frequency domain. However, such process may have the wireless device 405-b utilize a transformer 425 (e.g., an FFT) that covers the entire bandwidth of the reference signal 415, which may demand a relatively high-complexity receiver at the wireless device 405-b.

In some cases, prior to transmission of the reference signal 415, the wireless device 405-a may utilize a transformation procedure to transform the reference signal 415 into the time domain. For example, the wireless device 405-a may perform an IFFT procedure on the reference signal 415 that is within the frequency domain to obtain the reference signal 415 within the time domain. In some approaches, a reference signal in the frequency domain may be denoted X_{ref}[k], ∀k ∈ [0, MN−1] or a reference signal in the time domain may be denoted x_{ref}=IFFT_{MN}(X_{ref}), where the value of N may be in the form of 2^{a} where a is a positive integer, M may be a positive integer, and IFFT_{MN} may denote an IFFT with length MN. The wireless device 405-a may then transmit the reference signal 415 (e.g., x_{ref} in the time domain) via a channel (e.g., the communication link 410) and the wireless device 405-b may receive a convolution of the reference signal 415 by a channel impulse response, h (e.g., γᵣₓ=convolution (xᵣₓ, h), where γᵣₓ may denote a reference signal received via a channel in the time domain).

After receiving the reference signal 415, in some approaches, the wireless device 405-b may perform a transformation procedure to transform the reference signal 415 from the time domain to the frequency domain. For example, the wireless device 405-b may perform an FFT procedure to obtain the reference signal 415 (e.g., received reference signal) within the frequency domain, Yᵣₓ (e.g., Yᵣₓ=FFT_{MN} (γᵣₓ), where FFT_{MN} denotes an FFT with length MN or an MN-point FFT). Additionally, or alternatively, the FFT procedure may have a complexity of O(MNlog (MN). The wireless device 405-b may then obtain the frequency domain channel estimate, Hₑₛₜ[k], for all the tones (e.g., all the tones included in the reference signal) by removing the reference signal, x_{ref}[k], from the received signal in the frequency domain,

$${Y}_{rx} [ k ] ( e . g . , {H}_{est} [ k ] = {H}_{rx} [ k ] = \frac{{Y}_{rx} [ k ]}{{X}_{ref} [ k ]} , ∀ k ∈ [ 0 , N - 1 ] ) .$$

Additionally, or alternatively, the reference signal removal procedure may have a complexity of O(MN).

In some cases, for location procedures, sensing procedures, sounding procedures, or any combination thereof, the wireless device 405-b may also generate a decimated version of the channel estimate, Ĥₑₛₜ, that may be based on a reduction factor, M (e.g., Ĥₑₛₜ[k]=Ĥₑₛₜ[Mk], ∀k ∈ [0, N-1] or Ĥₑₛₜ[k]=Hᵣₓ[Mk]∀k ∈ [0, N-1]). In some approaches, the reduction factor M may be referred to as a decimation factor. In some approaches, the decimated version of the channel estimate may be sufficiently accurate for performing one or more location, sensing, or sounding procedures. Further, the complexity of the decimation procedure may be O(N). As the wireless device 405-b calculates the channel estimate prior to performing the decimation, the complexity, delay, or power consumption associated with calculating the channel estimate and performing the decimation may be relatively large. Further, some low-power devices may be unable to perform such procedures due to the complexity or power consumption associated with the procedures. For example, the computational complexity to perform the FFT procedure, the reference signal removal, and the decimation procedure may be αMNlog(MN)+βMN+γN, which may be too complex for some low-power devices (e.g., the wireless device 405-b). Therefore, the techniques of the present disclosure may describe the wireless device 405-b estimating a channel estimate (e.g., Ĥₑₛₜ) that may be based on a difference (e.g., comparison, division, or other operation) of a received reference signal and reference signal information with a relatively lower complexity given the reference signal 415, γᵣₓ, that is received.

In accordance with some of the techniques of the present disclosure, the wireless device 405-b may perform one or more operations to estimate a decimated frequency domain channel using a relatively smaller transformation procedure (e.g., a smaller FFT). For example, the wireless device 405-b may utilize a signal processor 420 to obtain a second set of samples 430 that are based on a first set of samples of the reference signal 415. The second set of samples 430 may include a combination of samples, at an interval in the time domain, of the first set of samples of the reference signal 415. For instance, the wireless device 405-b (e.g., signal processor 420) may combine or sum samples of the first set of samples at integer multiples of N to generate the second set of samples 430. Additionally, or alternatively, a quantity of samples within the second set of samples 430 may be less than a quantity of samples within the first set of samples of the reference signal 415. The wireless device 405-b may use a transformer 425 to transform the second set of samples 430 from the time domain to the frequency domain to obtain a frequency domain set of samples 435 of the second set of samples 430.

In some approaches, the wireless device 405-b may perform one or more operations 440 utilizing a channel estimate that is based on the frequency domain set of samples 435 that represent the second set of samples 430 transformed to the frequency domain. In some examples, the one or more operations 440 may include utilizing the channel estimate for one or more positioning procedures (e.g., procedure(s) for determining a position of the wireless device 405-a, of the wireless device 405-b, or of another object), sensing procedures (e.g., sensing data related to one or more objects), channel sounding procedures, or any combination thereof.

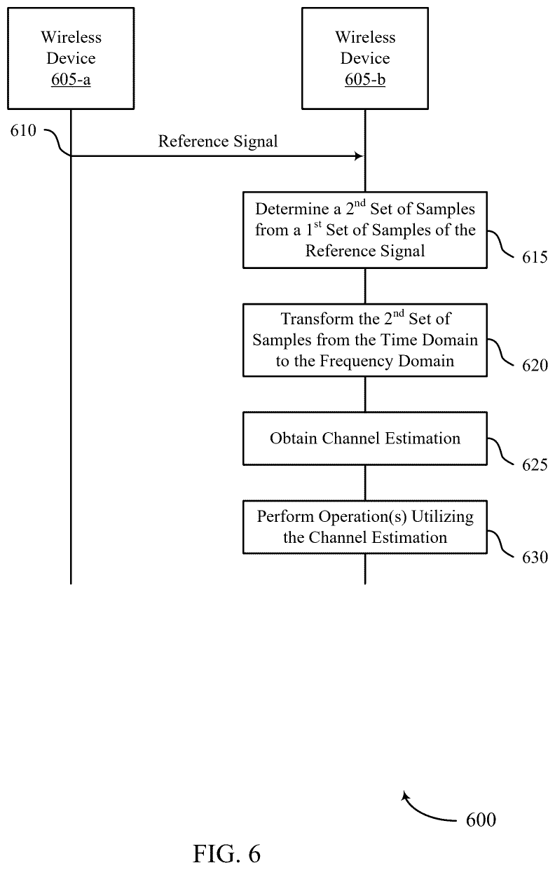

Therefore, the techniques of the present disclosure may describe the wireless device 405-b performing a processing procedure, via the signal processor 420, that includes a sequence of operations to estimate decimated frequency-domain channel estimates with a relatively smaller transformation procedure. Moreover, the techniques of the present disclosure may relatively significantly reduce the cost of receiver design which can benefit low-cost devices (e.g., the wireless device 405-b) that are configured for one or more location, sensing, or sounding procedures. Further descriptions of the techniques of the present disclosure may be described elsewhere herein, such as with reference to FIGS. 5 and 6.

FIG. 5 shows an example of a wireless communications system 500 that supports channel estimation based on time domain signals in accordance with one or more aspects of the present disclosure. The wireless communications system 500 may implement aspects of or may be implemented by aspects of the wireless communications system 100, the wireless communications system 400, or both. The wireless communications system 500 may include a wireless device 505-a or a wireless device 505-b. In some examples, the wireless device 505-a, the wireless device 505-b, or both may be examples of a UE 115, network node 105, RU 170, DU 165, or CU 160 described with reference to FIG. 1, a UE 115-a, gNB 255, RU 170-a, DU 165-a, CU 160-a, or ng-eNB 260 described with reference to FIG. 2, or a UE 115-b, RU 170-b, DU 165-b, or CU 160-b described with reference to FIG. 3. In some other examples, the wireless device 505-a, the wireless device 505-b, or both may be examples of a network node 105, location server 185, RU 170, DU 165, or CU 160 described with reference to FIG. 1, an LMF 265, external device 230, SLP 235, AMF 210, SMF 220, UPF 215, gNB 255, RU 170-a, DU 165-a, CU 160-a, or ng-eNB 260 described with reference to FIG. 2, an RU 170-b, DU 165-b, or CU 160-b described with reference to FIG. 3, an SnMF, or another device. Additionally, or alternatively, the wireless device 505-a and the wireless device 505-b may be examples of the wireless device 405-a and the wireless device 405-b respectively described with reference to FIG. 4. The wireless device 505-a may be a transmitter device or the wireless device 505-b may be a receiver device. One or more of the wireless device 505-a or the wireless device 505-b may be a transmitter device, receiver device, or a combination thereof.

In some examples, the wireless device 505-a and the wireless device 505-b may communicate via a communication link 510. The communication link 510 may be an example of a Uu link, a sidelink, a backhaul link, a D2D link, or another type of communication link 125 described herein with reference to FIGS. 1-3. In some examples, the wireless device 505-a may transmit a reference signal 515 to the wireless device 505-b via the communication link 510.

Prior to transmission of the reference signal 515, the wireless device 505-a may perform a transformation procedure 520 to generate the reference signal 515. In some examples, the transformation procedure 520 may include the wireless device 505-a transforming a reference signal 525 (e.g., X_{ref}) that is in the frequency domain into the reference signal 515 that is in the time domain (e.g., X_{ref}) via an IFFT procedure 530. The wireless device 505-a may then transmit the reference signal 515 to the wireless device 505-b via the communication link 510

After receiving the reference signal 515, in accordance with some of the techniques of the present disclosure, the wireless device 505-b may perform one or more operations 535 (e.g., a sequence of operations) to determine a frequency domain channel estimate (e.g., a reduced-complexity channel estimate, a “decimated” channel estimate, or a condensed channel estimate, among other examples) of the communication link 510 without performing a decimation procedure (e.g., without performing decimation on an FFT output or without performing decimation on a channel estimate in the frequency domain). For example, within the one or more operations 535, the wireless device 505-b may receive the reference signal 515 via a channel, which may be expressed as a convolution 540 of the reference signal 515 by a channel impulse response, h (e.g., γᵣₓ=convolution (xᵣₓ, h). The wireless device 505-b may utilize a signal processor 545 to perform a procedure (e.g., a pre-processing procedure, complexity reduction procedure, or signal condensation procedure, among other examples) that results in the wireless device 505-b obtaining a set of samples that includes a combination of samples from the convolution 540 of the reference signal 515 (e.g., γᵣₓ₁[n]).

In some examples, the procedure performed by the signal processor 545 may result in the wireless device 505-b obtaining a second set of samples 550 by combining samples from a first set of samples of the convolution 540 of the reference signal 515 at an interval in the time domain. In some aspects, the wireless device 405-b (e.g., signal processor 420) may combine or sum samples of the first set of samples at integer multiples of N to generate the second set of samples 430. For example, the signal processor 545 may combine each fourth sample of the reference signal 515 by summing the samples at an interval of four to thus generate a set of samples where each sample of the second set is a sum of samples of the first set. Therefore, in accordance with the techniques of the present disclosure, a quantity of samples within the second set of samples 550 (e.g., the set including combination of samples) may be less than a quantity of samples within the first set of samples of the reference signal 515. In an example, the first set of samples of the reference signal 515 may include 20 samples and the signal processor 545 may pre-process the reference signal by summing up samples at an interval of four (e.g., N=4) with a reduction factor of five (e.g., M=5). In this example, the second set of samples may include 4 samples as the summing of samples may be interleaved. For example, a first sample of the second set of samples 550 (e.g., γᵣₓ₁[0]) may include a sum of a 1st sample (e.g., γᵣₓ[0]), a 5th sample (e.g., γᵣₓ[4]), a 9th sample (e.g., γᵣₓ[8]), a 13th sample (e.g., γᵣₓ[12]), and a 17th sample (e.g., γᵣₓ[16]) from the first set of samples of the reference signal 515. A second sample of the second set of samples 550 (e.g., γᵣₓ₁[1]) may include a sum of a 2nd sample (e.g., γᵣₓ[1]), a 6th sample (e.g., γᵣₓ[5]), a 10th sample (e.g., γᵣₓ[9]), a 14th sample (e.g., γᵣₓ[13]), and a 18th sample (e.g., γᵣₓ[17]) of the first set of samples of the reference signal 515. A third sample (e.g., γᵣₓ₁[2]) and a fourth sample (e.g., γᵣₓ₁[3]) of the second set of samples 550 may also be determined by summing respective sets of samples from the first set of samples at an interval of four. Accordingly, the combination of samples in the second set of samples 550 may include four samples (e.g., γᵣₓ₁[0], γᵣₓ₁[1], γᵣₓ₁[2], γᵣₓ₁[3]), where each sample may be a sum of interleaved samples from the first set of samples of the reference signal 515, which may result in a relatively smaller quantity of samples. Some examples of the pre-processing procedure performed by the signal processor 545 may be performed in accordance with Equation 1 below.

$${y}_{rx 1} [ n ] = {\sum }_{i = 0}^{M - 1} {y}_{rx} [ n + Ni ] , ∀ n ∈ [ 0 , N - 1 ] \qquad ( 1 )$$

In Equation 1 above, γᵣₓ₁[n] may represent the second set of samples 550, M may represent a reduction factor, n may represent a respective sample of the first set of samples of the reference signal 515, and N may represent a quantity of samples within the second set of samples 550 (e.g., an interval in the time domain expressed in a quantity of samples). In some cases, the value of M may be negotiated between the wireless device 505-a and the wireless device 505-b via a channel sensing procedure. In some other cases, the value of M may be negotiated between the wireless device 505-a and the wireless device 505-b via a coordinated beamforming (CBF) sounding feedback procedure used for beamforming by the wireless device 505-a (e.g., the transmitter device). In some aspects, the reduction factor indicated by the value of M may indicate a rate at which a sampling rate of a signal (e.g., the reference signal 515) is reduced). Additionally, or alternatively, the complexity of the pre-processing procedure may be 0 (MN).

After determining the second set of samples 550 via the signal processor 545, the wireless device 505-b may transform the second set of samples 550 via an FFT procedure 555. In some aspects, the wireless device 505-b may utilize the FFT procedure 555 to transform the second set of samples 550 from the time domain to a second set of samples 560 that are in the frequency domain (e.g., Yᵣₓ₁[k]=FFT_{N}(γᵣₓ₁)). For example, the FFT procedure 555 may transform samples from the time domain to the frequency domain. In some examples, the FFT procedure 555 may be referred to as an N-point FFT and the IFFT procedure 530 may be referred to as an MN-point IFFT. The second set of samples 560 may correspond to the second set of samples 550, where the second set of samples 550 is in the time domain and the second set of samples 560 is in the frequency domain. The complexity of the FFT procedure 555 may be O(Nlog(N)).

Due to the pre-processing performed by the signal processor 545 of the wireless device 505-b, the size of the FFT procedure 555 may be relatively smaller than the IFFT procedure 530 which can result in reducing the complexity and time consumption of the associated transforming procedure (e.g., the FFT procedure 555). For example, some of the techniques of the present disclosure may include the wireless device 505-b obtaining a granular channel estimate using an FFT procedure 555 that is relatively smaller to reduce the complexity of obtaining a channel estimate. For example, due to performing the pre-processing procedure that enables the wireless device 505-b to perform the FFT procedure 555 using a relatively smaller quantity of samples than the IFFT procedure 530, the complexity of the FFT procedure 555 may be O(Nlog(N)). Therefore, by reducing the size of the FFT procedure 555 from MN to N, some of the techniques of the present disclosure may reduce the complexity of the FFT procedure 555 from O(MNlog(MN)) to O(Nlog(N)). For example, since the FFT procedure 555 is performed on a relatively smaller quantity of samples than the IFFT procedure 530, the complexity of the FFT procedure 555 can be reduced accordingly.

Using the second set of samples 560 that are in the frequency domain, the wireless device 505-b may further perform a reference signal removal procedure 565 to obtain the channel estimate of the communication link 510. The reference signal removal procedure 565 may include the wireless device 505-b estimating a channel estimate 570. For example, the wireless device 505-b may estimate a difference in samples that is between the second set of samples 560 that are in the frequency domain and reference signal information associated with the reference signal 525 that is in the frequency domain

$$( e . g . , {\hat{H}}_{est} [ k ] = \frac{{Y}_{rx 1} [ k ]}{{X}_{ref} [ Mk ]} ,$$

where X_{ref} is the reference signal 525 or a representation of the reference signal 525). The complexity of the reference signal removal procedure may be O(N). Thus, the computational complexity of the obtaining the channel estimate 570 via the sequence of operations of some of the techniques of the present disclosure may be ηMN+αNlog(N)+βN, where η, α, and β may be scalar values related to computational complexity.

The channel estimate 570 may be an estimate of the channel of the communication link 510 between the wireless device 505-a and the wireless device 505-b. Thus, in accordance with the techniques of the present disclosure, the wireless device 505-b may reduce the complexity of obtaining a channel estimate due to reducing the complexity of the FFT procedure 555, which may be the dominant operation in obtaining the channel estimate. Additionally, or alternatively, the techniques of the present disclosure may enable the wireless device 505-b the capability to obtain a decimated channel estimate with the FFT procedure 555 that is relatively smaller using the one or more operations 535.

Some examples of the techniques described herein may reduce the complexity of achieving a granular channel estimate 570 at a receiver (e.g., wireless device 505-b), where one or more operations 535 may be performed to achieve the channel estimate 570 with a reduced-size FFT. In some approaches, for instance, an FFT (e.g., FFT_{MN}) may be performed based on a complete received reference signal, followed by channel estimation, followed by decimation on the channel estimate. For instance, a decimator may be utilized in some approaches, where a full FFT across an entire signal bandwidth may be utilized, followed by post-processing the signal based on the decimation, where decimation may be used to reduce reporting. In some of the techniques described herein, pre-processing may be performed to reduce the size of the received reference signal before performing an FFT (e.g., FFT_{N}), which may enable use of a relatively smaller FFT. For instance, combining samples of the received reference signal at an interval in the time domain may have an effect of removing tones in the frequency domain (e.g., without directly removing tones via decimation after an FFT), which may enable use of a smaller FFT. After the FFT (e.g., smaller FFT or FFT_{N}), channel estimation may be performed. Performing reduction of a reference signal in pre-processing may determine a portion of the bandwidth (e.g., reduced tones) for measurement, which may save power.

In some examples, a channel estimate obtained without decimation in accordance with one or more of the techniques of the present disclosure may provide similar accuracy to a channel estimate obtained with decimation, while providing reduced computational complexity. For example, to ensure such accuracy in the channel estimate in accordance with some of the techniques of the present disclosure, the wireless device 505-b may perform one or more operations (e.g., pre-processing operations) in accordance with one or more of the following equations. In the example below, let X=FFT_{MN}(x), where X[Mk] may be estimated from x[n].

$$X [ k ] = {\sum }_{n = 0}^{MN - 1} x [ n ] {e}^{- \frac{j 2 π}{MN} nk} ∀ k ∈ [ 0 , MN - 1 ]$$

$$X [ Mk ] = {\sum }_{n = 0}^{MN - 1} x [ n ] {e}^{- \frac{j 2 π}{MN} n ( Mk )} ∀ k ∈ [ 0 , N - 1 ]$$

$$X [ Mk ] = {\sum }_{m = 0}^{M - 1} ( {\sum }_{n = 0}^{N - 1} x [ n + mN ] {e}^{- \frac{j 2 π}{MN} ( n + mN ) ( Mk )} )$$

$$X [ Mk ] = {\sum }_{m = 0}^{M - 1} ( {\sum }_{n = 0}^{N - 1} x [ n + mN ] {e}^{- \frac{j 2 π}{N} ( n + mN ) ( k )} )$$

$$X [ Mk ] = {\sum }_{m = 0}^{M - 1} ( {e}^{- \frac{j 2 π}{N} mNk} ( {\sum }_{n = 0}^{N - 1} x [ n + mN ] {e}^{- \frac{j 2 π}{N} nk} ) )$$

$$Further , as$$

$${e}^{- \frac{j 2 π}{N} mNk} = {e}^{- j 2 π mk} = 1 ∀ k ∈ [ 0 , N - 1 ] :$$

$$X [ Mk ] = {\sum }_{m = 0}^{M - 1} ( {\sum }_{n = 0}^{N - 1} x [ n + mN ] {e}^{- \frac{j 2 π}{N} nk} )$$

$$X [ Mk ] = {\sum }_{n = 0}^{N - 1} ( {\sum }_{m = 0}^{M - 1} x [ n + mN ] ) {e}^{- \frac{j 2 π}{N} nk}$$

$$X [ Mk ] = {\sum }_{n = 0}^{N - 1} {y}_{1} [ n ] {e}^{- \frac{j 2 π}{N} nk}$$

In such operations,

$${y}_{1} [ n ] = {\sum }_{m = 0}^{N - 1} y [ n + mN ] , ∀ n ∈ [ 0 , N - 1 ] .$$

Further, Y₁ may be equal to FFT_{N}(γ₁) (e.g., Y₁=FFT_{N}(γ₁)), which may be given as

$${Y}_{1} [ k ] = {\sum }_{n = 0}^{N - 1} y [ n ] {e}^{- \frac{j 2 π}{N} nk} , ∀ k ∈ [ 0 , N - 1 ] .$$

### Accordingly, X[Mk]=Y₁[k], ∀k ∈ [0, N-1].

In some examples, the wireless device 505-b may also utilize the channel estimate 570 that is based on the difference in samples that is a result of the reference signal removal procedure 565 to perform one or more operations 575. For example, the wireless device 505-b may perform one or more operations 575 utilizing a channel estimate that is based on the second set of samples 560 transformed to the frequency domain. In some cases, the one or more operations 575 utilizing the channel estimate may be associated with one or more positioning procedures, sensing procedures, channel sounding procedures, or any combination thereof. For instance, the channel estimate 570 may be utilized to manage (e.g., account for, reduce, or remove) the effect of the channel on one or more reference signals for positioning, sensing, or channel sounding (e.g., positioning reference signals (PRSs), sounding reference signals (SRSs), or another reference signal(s)). For example, the channel estimate 570 may increase reference signal reception accuracy with reduced complexity, which may improve one or more positioning measurements, sensing measurements, or channel sounding measurements. Additionally, or alternatively, in accordance with some of the techniques of the present disclosure, the one or more operations 575 for such procedures may be performed with a relative reduction in latency, power consumption, or cost due to the pre-processing procedure performed via the signal processor 545 that results in a reduced size for the FFT procedure 555.

Therefore, the techniques of the present disclosure may result in a relatively significant reduction in the computational complexity associated with the wireless device 505-b generating a channel estimate for one or more location (e.g., positioning), sensing, or sounding procedures and hardware design. For example, some of the techniques of the present disclosure may result in a power and area reduction, which can reduce the complexity of the procedures and result in a relatively low-cost design for a receiver (e.g., the wireless device 505-b). Additionally, or alternatively, some of the techniques of the present disclosure may result in an increase in power efficiency or a reduction in processing latency and cost associated with positioning, sensing, or sounding procedures, thus improving the efficiency and reliability of the wireless communications system 500. Moreover, the techniques of the present disclosure may improve the efficiency, reliability, and accuracy for various low-cost and low-power devices (e.g., wireless device 505-a or wireless device 505-b) such as wearable devices, IoT devices, Wi-Fi based devices, and the like. Further descriptions of the techniques of the present disclosure may be described elsewhere herein, such as with reference to one or more of FIG. 6 through FIG. 14.

FIG. 6 shows an example of a process flow 600 that supports channel estimation based on time domain signals in accordance with one or more aspects of the present disclosure. In some examples, the process flow 600 may implement or be implemented by the wireless communications system 100, the wireless communications system 400, the wireless communications system 500, or any combination thereof. For example, the process flow 600 may include a wireless device 605-a and a wireless device 605-b which may be examples of devices described herein with reference to FIGS. 1 and 4-5.

In the following description of the process flow 600, the operations between the wireless device 605-a and the wireless device 605-b may be performed in different orders or at different times. Some operations may also be left out of the process flow 600, or other operations may be added. Although the wireless device 605-a and the wireless device 605-b are shown performing the operations of the process flow 600, some aspects of some operations may also be performed by one or more other wireless devices.

At 610, the wireless device 605-b may receive, from the wireless device 605-a, a reference signal via a communication channel between the wireless device 605-a and the wireless device 605-b. In some cases, the reference signal may also be associated with a multi-stream communication.

At 615, the wireless device 605-b may determine, within a time domain, a second set of samples that is based on a first set of samples of the reference signal. Moreover, the second set of samples may include a combination of samples, at an interval in the time domain, of the first set of samples. Further, a second quantity of the second set of samples may be less than a first quantity of the first set of samples. In some examples, the second quantity of the second set of samples may be based on the interval in the time domain. Additionally, or alternatively, the wireless device 605-b may determine the second set of samples based on a processing procedure.

At 620, the wireless device 605-b may transform the second set of samples from the time domain to a frequency domain based on the second quantity of the second set of samples. In some examples, the wireless device 605-b may perform an FFT on the second set of samples to transform the second set of samples from the time domain to the frequency domain. Further, the FFT may be an N-point FFT that is based on the interval (e.g., an N-sample interval) in the time domain. Additionally, or alternatively, the wireless device 605-b may communicate an indication of a factor (e.g., reduction factor or M) with the wireless device 605-a where the reference signal may be based on an IFFT at the wireless device 605-a and a size of the N-point FFT may be an integer divisor of a size of the IFFT that is based on the factor. Moreover, the processing procedure for determining the second set of samples may be before transforming the second set of samples from the time domain to the frequency domain.

At 625, the wireless device 605-b may estimate a difference between the second set of samples in the frequency domain and reference signal information to obtain the channel estimation of the communication channel between the wireless device 605-a and the wireless device 605-b. At 630, the wireless device 605-b may perform one or more operations utilizing a channel estimation that is based on the second set of samples transformed to the frequency domain. In some examples, performing the one or more operations utilizing the channel estimation may be based on obtaining the channel estimation. Further, the one or more operations utilizing the channel estimation may be associated with one or more positioning procedures, one or more sensing procedures, one or more channel sounding procedures, or any combination thereof.

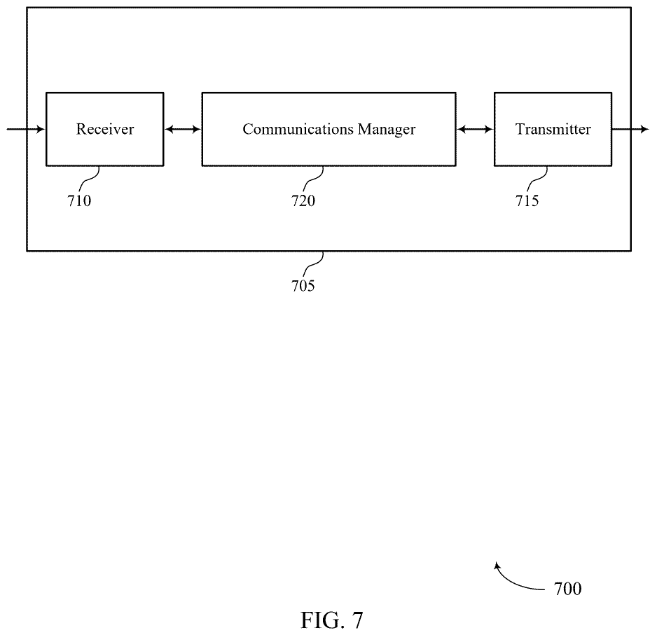

FIG. 7 shows a block diagram 700 of a device 705 that supports channel estimation based on time domain signals in accordance with one or more aspects of the present disclosure. The device 705 may be an example of aspects of a wireless device as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to channel estimation based on time domain signals). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel estimation based on time domain signals). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of channel estimation based on time domain signals as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a reference signal from a second wireless device via a communication channel between the first wireless device and the second wireless device. The communications manager 720 is capable of, configured to, or operable to support a means for determining, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples. The communications manager 720 is capable of, configured to, or operable to support a means for transforming the second set of multiple samples from the time domain to a frequency domain based on the second quantity of the second set of multiple samples. The communications manager 720 is capable of, configured to, or operable to support a means for performing one or more operations utilizing a channel estimation that is based on the second set of multiple samples transformed to the frequency domain.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for obtaining a decimated channel estimate with a relatively smaller FFT based on a pre-processing procedure to support reduced processing, reduced power consumption, and more efficient utilization of communication resources.

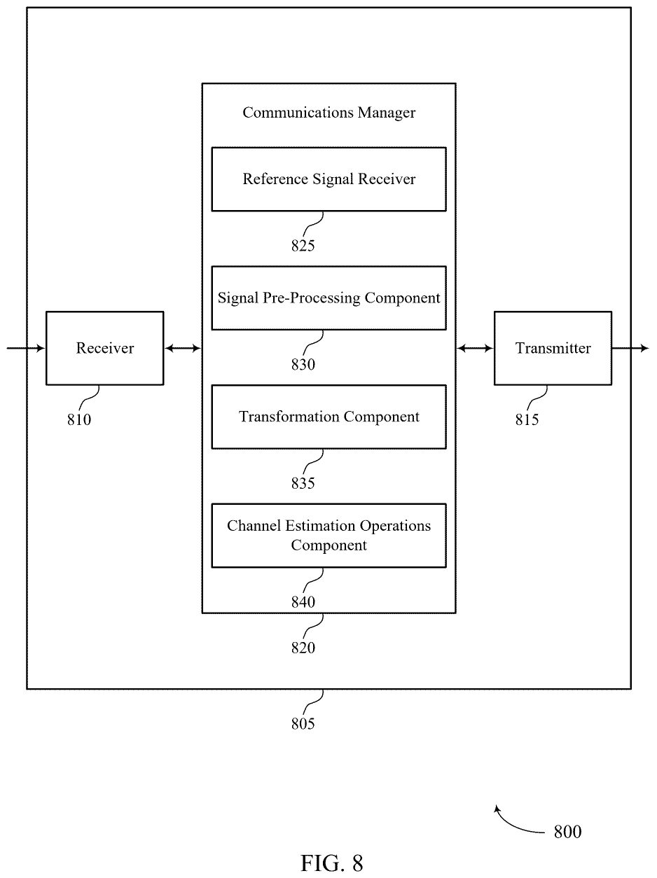

FIG. 8 shows a block diagram 800 of a device 805 that supports channel estimation based on time domain signals in accordance with one or more aspects of the present disclosure. The device 805 may be an example of aspects of a device 705 or a wireless device as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to channel estimation based on time domain signals). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to channel estimation based on time domain signals). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of channel estimation based on time domain signals as described herein. For example, the communications manager 820 may include a reference signal receiver 825, a signal pre-processing component 830, a transformation component 835, a channel estimation operations component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The reference signal receiver 825 is capable of, configured to, or operable to support a means for receiving a reference signal from a second wireless device via a communication channel between the first wireless device and the second wireless device. The signal pre-processing component 830 is capable of, configured to, or operable to support a means for determining, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples. The transformation component 835 is capable of, configured to, or operable to support a means for transforming the second set of multiple samples from the time domain to a frequency domain based on the second quantity of the second set of multiple samples. The channel estimation operations component 840 is capable of, configured to, or operable to support a means for performing one or more operations utilizing a channel estimation that is based on the second set of multiple samples transformed to the frequency domain.

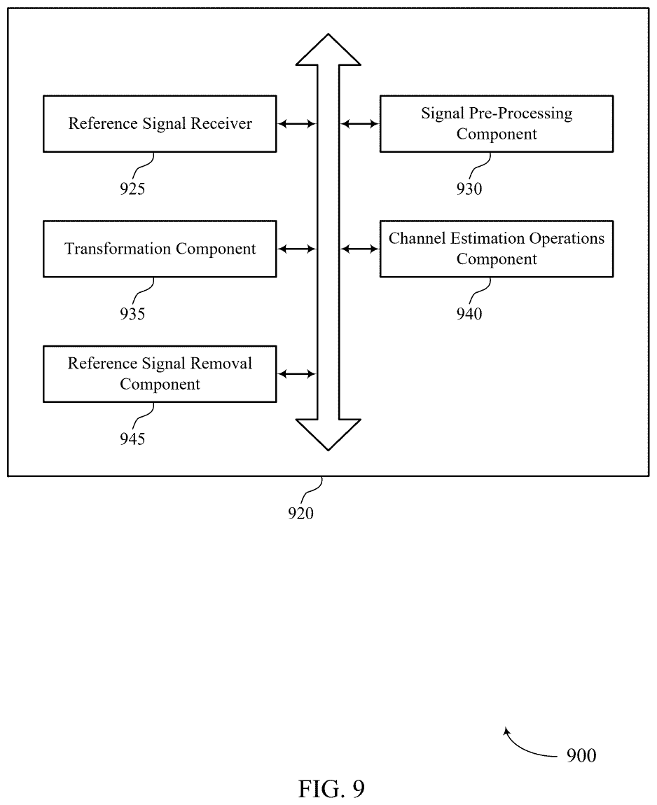

FIG. 9 shows a block diagram 900 of a communications manager 920 that supports channel estimation based on time domain signals in accordance with one or more aspects of the present disclosure. The communications manager 920 may be an example of aspects of a communications manager 720, a communications manager 820, or both, as described herein. The communications manager 920, or various components thereof, may be an example of means for performing various aspects of channel estimation based on time domain signals as described herein. For example, the communications manager 920 may include a reference signal receiver 925, a signal pre-processing component 930, a transformation component 935, a channel estimation operations component 940, a reference signal removal component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The reference signal receiver 925 is capable of, configured to, or operable to support a means for receiving a reference signal from a second wireless device via a communication channel between the first wireless device and the second wireless device. The signal pre-processing component 930 is capable of, configured to, or operable to support a means for determining, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples. The transformation component 935 is capable of, configured to, or operable to support a means for transforming the second set of multiple samples from the time domain to a frequency domain based on the second quantity of the second set of multiple samples. The channel estimation operations component 940 is capable of, configured to, or operable to support a means for performing one or more operations utilizing a channel estimation that is based on the second set of multiple samples transformed to the frequency domain.

In some examples, the reference signal removal component 945 is capable of, configured to, or operable to support a means for estimating a difference between the second set of multiple samples in the frequency domain and reference signal information to obtain the channel estimation of the communication channel between the first wireless device and the second wireless device, where performing the one or more operations utilizing the channel estimation is based on obtaining the channel estimation.

In some examples, to support transforming the second set of multiple samples, the transformation component 935 is capable of, configured to, or operable to support a means for performing a fast Fourier transform (FFT) on the second set of multiple samples to transform the second set of multiple samples from the time domain to the frequency domain.

In some examples, the fast Fourier transform is an N-point FFT that is based on the interval in the time domain.

In some examples, the transformation component 935 is capable of, configured to, or operable to support a means for communicating an indication of a factor with the second wireless device, where the reference signal is based on an inverse fast Fourier transform (IFFT) at the second wireless device, where a size of the N-point FFT is an integer divisor of a size of the IFFT that is based on the factor.

In some examples, the second quantity of the second set of multiple samples is based on the interval in the time domain.

In some examples, the reference signal is associated with a multi-stream communication.

In some examples, determining the second set of multiple samples is based on a processing procedure before transforming the second set of multiple samples from the time domain to the frequency domain.

In some examples, the one or more operations utilizing the channel estimation are associated with one or more positioning procedures, one or more sensing procedures, one or more channel sounding procedures, or any combination thereof.

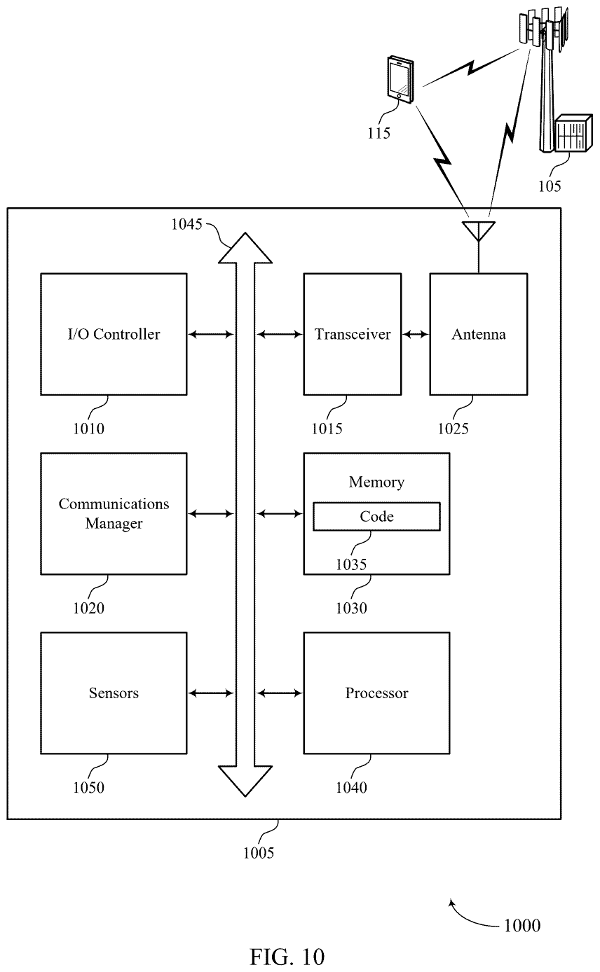

FIG. 10 shows a diagram of a system 1000 including a device 1005 that supports channel estimation based on time domain signals in accordance with one or more aspects of the present disclosure. The device 1005 may include components for bi-directional voice and data communications including components for transmitting and receiving communications, such as a communications manager 1020, an I/O controller, such as an I/O controller 1010, one or more transceivers 1015, one or more antennas 1025, at least one memory 1030, code 1035, and at least one processor 1040. The device 1005 may include one or more sensors 1050. These components may be in electronic communication or otherwise coupled (e.g., operatively, communicatively, functionally, electronically, electrically) via one or more buses (e.g., a bus 1045). The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver(s) 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The one or more transceivers 1015 may include one or more wireless wide area network (WWAN) transceivers, one or more short-range wireless transceivers, or one or more satellite transceivers. The WWAN transceiver(s) may communicate with (e.g., transmit one or more signals to, or receive one or more signals from) one or more wireless communication networks, such as an NR network, an LTE network, or a GSM network, among other examples. The WWAN transceiver(s) may be connected to one or more of the antenna(s) 1025 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1025 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), or UWB, among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, vehicle-to-vehicle (V2V) transceivers, or vehicle-to-everything (V2X) transceivers, among other examples.

The satellite transceiver(s) may include one or more satellite signal receivers, or one or more satellite signal transmitters. In some cases, the device 1005 may be a terrestrial device that may communicate one or more satellites via the satellite transceiver(s). In other cases, device 1005 may be a satellite (or other non-terrestrial entity) that uses the satellite transceiver(s) to communicate with one or more terrestrial networks or other satellites.

The satellite signal receiver(s) may be connected to one or more of the antenna(s) 1025 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, Indian Regional Navigation Satellite System (NAVIC), or Quasi-Zenith Satellite System (QZSS) signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1040 may perform calculations to determine a location of the device 1005, the UE 115, the network node 105, or another device using measurements obtained from one or more satellite signals.

The one or more satellite signal transmitters may be connected to one or more of the antennas 1025 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The device 1005 may include one or more sensors 1050 coupled with the one or more processors 1040 for obtaining sensor data (e.g., image data, RF data, motion data, orientation data, or audio data, among other examples). For example, the one or more sensors 1050 may sense or detect movement or orientation information. In some aspects, the movement or orientation information may be independent from motion data derived from signals received by the one or more WWAN transceivers, the one or more short-range wireless transceivers, or the satellite signal interface. In some examples, the sensor(s) 1050 may include an accelerometer (e.g., a micro-electrical mechanical systems (MEMS) device), a gyroscope, a geomagnetic sensor (e.g., a compass), an altimeter (e.g., a barometric pressure altimeter), or any other type of movement detection sensor. Additionally, or alternatively, the one or more sensors 1050 may include an image sensor, camera, microphone, light detector, or pressure sensor, among other examples. In some aspects, the sensor(s) 1050 may include a plurality of different types of devices, and the device 1005 (e.g., sensor(s) 1050 or processor(s) 1040) may combine the outputs of the different types of devices to provide motion information. For example, the sensor(s) 1050 may use a combination of a multi-axis accelerometer sensors, orientation sensors, or image sensors to provide the ability to compute positions in two-dimensional (2D) or three-dimensional (3D) coordinate systems.

The at least one memory 1030 may include RAM and ROM. The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a BIOS which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting channel estimation based on time domain signals) For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a reference signal from a second wireless device via a communication channel between the first wireless device and the second wireless device. The communications manager 1020 is capable of, configured to, or operable to support a means for determining, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples. The communications manager 1020 is capable of, configured to, or operable to support a means for transforming the second set of multiple samples from the time domain to a frequency domain based on the second quantity of the second set of multiple samples. The communications manager 1020 is capable of, configured to, or operable to support a means for performing one or more operations utilizing a channel estimation that is based on the second set of multiple samples transformed to the frequency domain.

By including or configuring the communications manager 1020 in accordance with examples as described herein, the device 1005 may support techniques for obtaining a decimated channel estimate with a relatively smaller FFT based on a pre-processing procedure to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of channel estimation based on time domain signals as described herein, or the at least one processor 1040 and the at least one memory 1030 may be otherwise configured to, individually or collectively, perform or support such operations.

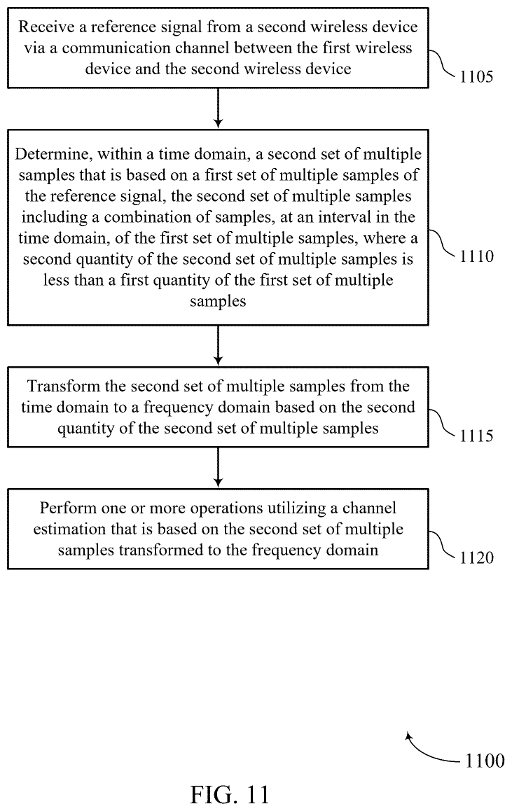

FIG. 11 shows a flowchart illustrating a method 1100 that supports channel estimation based on time domain signals in accordance with one or more aspects of the present disclosure. The operations of the method 1100 may be implemented by a wireless device or its components as described herein. For example, the operations of the method 1100 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1105, the method may include receiving a reference signal from a second wireless device via a communication channel between the first wireless device and the second wireless device. The operations of 1105 may be performed in accordance with examples as disclosed herein. In some examples, aspects of the operations of 1105 may be performed by a reference signal receiver 925 as described with reference to FIG. 9.

At 1110, the method may include determining, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples. The operations of 1110 may be performed in accordance with examples as disclosed herein. In some examples, aspects of the operations of 1110 may be performed by a signal pre-processing component 930 as described with reference to FIG. 9.

At 1115, the method may include transforming the second set of multiple samples from the time domain to a frequency domain based on the second quantity of the second set of multiple samples. The operations of 1115 may be performed in accordance with examples as disclosed herein. In some examples, aspects of the operations of 1115 may be performed by a transformation component 935 as described with reference to FIG. 9.

At 1120, the method may include performing one or more operations utilizing a channel estimation that is based on the second set of multiple samples transformed to the frequency domain. The operations of 1120 may be performed in accordance with examples as disclosed herein. In some examples, aspects of the operations of 1120 may be performed by a channel estimation operations component 940 as described with reference to FIG. 9.

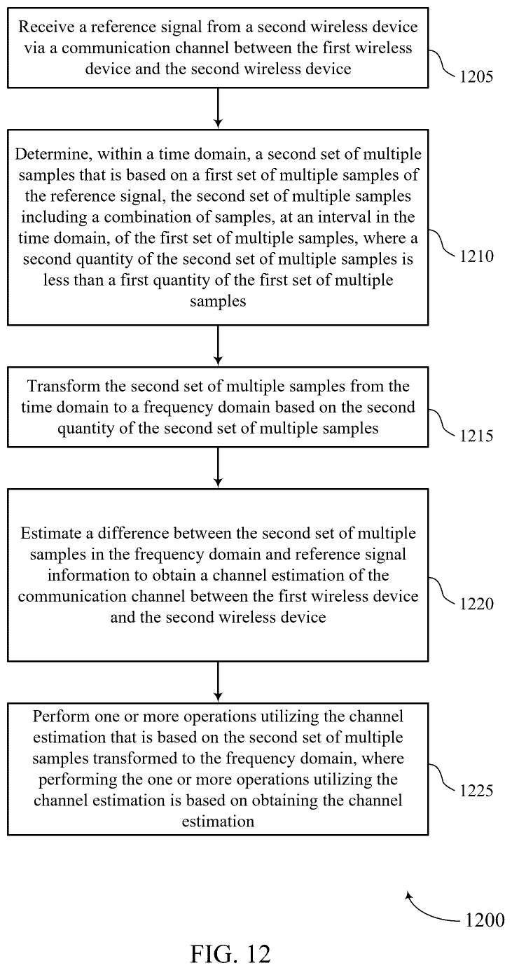

FIG. 12 shows a flowchart illustrating a method 1200 that supports channel estimation based on time domain signals in accordance with one or more aspects of the present disclosure. The operations of the method 1200 may be implemented by a wireless device or its components as described herein. For example, the operations of the method 1200 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1205, the method may include receiving a reference signal from a second wireless device via a communication channel between the first wireless device and the second wireless device. The operations of 1205 may be performed in accordance with examples as disclosed herein. In some examples, aspects of the operations of 1205 may be performed by a reference signal receiver 925 as described with reference to FIG. 9.

At 1210, the method may include determining, within a time domain, a second set of multiple samples that is based on a first set of multiple samples of the reference signal, the second set of multiple samples including a combination of samples, at an interval in the time domain, of the first set of multiple samples, where a second quantity of the second set of multiple samples is less than a first quantity of the first set of multiple samples. The operations of 1210 may be performed in accordance with examples as disclosed herein. In some examples, aspects of the operations of 1210 may be performed by a signal pre-processing component 930 as described with reference to FIG. 9.

At 1215, the method may include transforming the second set of multiple samples from the time domain to a frequency domain based on the second quantity of the second set of multiple samples. The operations of 1215 may be performed in accordance with examples as disclosed herein. In some examples, aspects of the operations of 1215 may be performed by a transformation component 935 as described with reference to FIG. 9.

At 1220, the method may include estimating a difference between the second set of multiple samples in the frequency domain and reference signal information to obtain a channel estimation of the communication channel between the first wireless device and the second wireless device. The operations of 1220 may be performed in accordance with examples as disclosed herein. In some examples, aspects of the operations of 1220 may be performed by a reference signal removal component 945 as described with reference to FIG. 9.

At 1225, the method may include performing one or more operations utilizing the channel estimation that is based on the second set of multiple samples transformed to the frequency domain, where performing the one or more operations utilizing the channel estimation is based on obtaining the channel estimation. The operations of 1225 may be performed in accordance with examples as disclosed herein. In some examples, aspects of the operations of 1225 may be performed by a channel estimation operations component 940 as described with reference to FIG. 9.

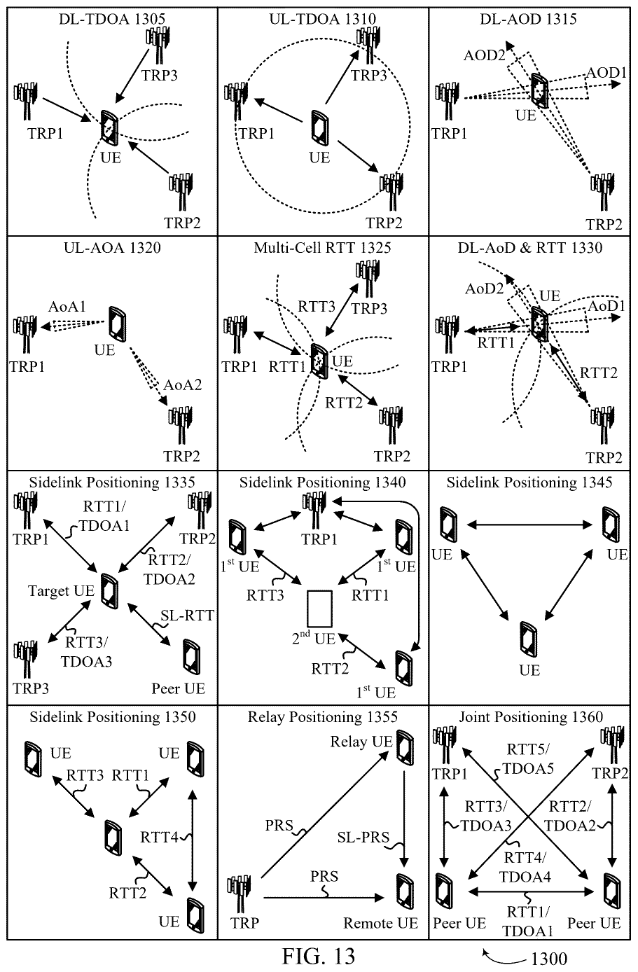

FIG. 13 shows examples of wireless communications systems 1300 that support channel estimation based on time domain signals in accordance with one or more aspects of the present disclosure. Various positioning techniques are illustrated in the context of the wireless communications systems 1300. Some examples of the positioning procedures described herein may be performed in accordance with one or more aspects of the positioning techniques. While TRPs and UEs are provided in the examples illustrated in FIG. 13, other devices (e.g., network entities, base stations, RRHs, RUs, APs, wireless devices, or stations, among other examples) may be similarly utilized in other examples. The examples of positioning techniques include downlink-based positioning techniques, uplink-based positioning techniques, and downlink-and-uplink-based positioning techniques.

Examples of OTDOA or DL-TDOA 1305 are illustrated in FIG. 13. One or more of the OTDOA or DL-TDOA 1305 positioning techniques may be included in a downlink-based positioning procedure. In OTDOA or DL-TDOA 1305 positioning techniques, a UE may measure a difference between TOAs of reference signals (e.g., PRSs) received from one or more pairs of TRPs (e.g., TRP2 and TRP3). In some approaches, a difference in TOAs may be referred to as an RSTD or a TDOA measurement. A positioning device (e.g., the UE, a location server, an LMF, an SLP, or another device) may utilize the differences in TOAs to determine (e.g., estimate) a location of the UE.

In some aspects, the UE may receive an identifier (ID) associated with a reference TRP (e.g., a serving base station) and one or more IDs associated with one or more non-reference TRPs in received data (e.g., assistance data). The UE may measure the difference of TOAs between the reference TRP and each of the non-reference TRPs to produce RSTDs or TDOAs. In some aspects, the UE may report an indication of the RSTDs or TDOAs to the positioning device (e.g., a location server, LMF, an SLP, or another device). Based on established locations of the base stations and the RSTD measurements, the positioning device (e.g., the UE for UE-based positioning or a location server for UE-assisted positioning) may estimate the UE's location.

An example of UL-TDOA 1310 is illustrated in FIG. 13. One or more of the UL-TDOA 1310 positioning techniques may be included in an uplink-based positioning procedure. UL-TDOA 1310 may have some similarities to DL-TDOA 1305. The UL-TDOA 1310 positioning techniques may be based on uplink reference signals (e.g., SRS) transmitted from the UE to multiple TRPs. For example, the UE transmits one or more uplink reference signals that are measured by a reference TRP (e.g., TRP3) and non-reference TRPs (e.g., TRP1 and TRP2). Each TRP then reports the reception time (which may be referred to as a relative time of arrival (RTOA)) of the reference signal(s) to a positioning device (e.g., a location server, LMF, SLP, or UE) that has information about the locations and relative timing of the TRPs. Based on the reception-to-reception (Rx-Rx) time differences between the reported RTOA of the reference TRP and the reported RTOA of each non-reference TRP, the locations of the TRPs, and the corresponding timing offsets, the positioning device may estimate the location of the UE using TDOA.

An example of DL-AOD 1315 is illustrated in FIG. 13. One or more of the DL-AOD 1315 positioning techniques may be included in a downlink-based positioning procedure. In DL-AOD 1315, a UE may obtain received signal strength measurements corresponding to multiple downlink transmit beams for one or more TRPs (e.g., TRP1 and TRP2). In some approaches, the UE reports the measurements to a positioning device. The positioning device may use the signal strength measurements of the multiple downlink transmit beams to determine the angle(s) (e.g., AOD1 and AOD2) between the UE and the transmitting TRP(s). The positioning device (e.g., location server, LMF, SLP, UE, or another device) may estimate the location of the UE based on the determined angle(s) and the established location(s) of the transmitting TRP(s).

An example of UL-AOA 1320 is illustrated in FIG. 13. One or more of the UL-AOA 1320 positioning techniques may be included in an uplink positioning procedure. In UL-AOA 1320, one or more TRPs (e.g., TRP1 and TRP2) measure the received signal strength of one or more uplink reference signals (e.g., SRSs) received from a UE on one or more uplink receive beams. In some aspects, the signal strength measurements may be reported to a positioning device. A positioning device (e.g., LFM, SLP, UE, or another device) may use the signal strength measurements and the angle(s) of the receive beam(s) to determine the angle(s) between the UE and the TRP(s). Based on the determined angle(s) and the established location(s) of the TRP(s), the positioning device may estimate the location of the UE.

Some positioning techniques or procedures may include a combination downlink-based and uplink-based positioning techniques. Examples of downlink-based and uplink-based positioning techniques may include E-CID positioning and mRTT positioning (which may be referred to as “multi-RTT” or “multi-cell RTT” when multiple cells are utilized).

In multi-RTT, a first device (e.g., a TRP or UE) may transmit a first RTT-related signal (e.g., a PRS or SRS) to a second device (e.g., the UE or TRP). The second device may transmit a second RTT-related signal (e.g., an SRS or PRS) back to the first device. Each device may measure a time difference between the TOA of the received RTT-related signal and the transmission time of the transmitted RTT-related signal. The time difference may be referred to as a reception-to-transmission (Rx-Tx) time difference. In some aspects, the Rx-Tx time difference measurement may be obtained or adjusted to include (e.g., include only) a time difference between nearest slot boundaries for the received and transmitted signals. The first device or the second device may send the corresponding Rx-Tx time difference measurements to a positioning device (e.g., a location server, LMF, SLP, UE, or other device), which may calculate a round trip propagation time (or RTT) between the two device based on the two Rx-Tx time difference measurements (e.g., as a sum of the two Rx-Tx time difference measurements). Additionally, or alternatively, one device may send a corresponding Rx-Tx time difference measurement to the other device, which may calculate the RTT. The distance between the two devices may be determined from the RTT and a signal speed (e.g., the speed of light).

An example of multi-cell RTT 1325 is illustrated in FIG. 13. One or more of the multi-RTT or multi-cell RTT techniques described may be included in an uplink-based or downlink-based positioning procedure. In multi-cell RTT 1325, a first device (e.g., a UE or TRP) may perform an RTT positioning procedure with multiple second devices (e.g., multiple TRPs or UEs) to enable the location of the first device to be determined (e.g., using multilateration) based on distances to, and the established locations of, the second devices.

In some examples, RTT or multi-RTT techniques may be combined with one or more other positioning techniques (e.g., UL-AOA, DL-AOD, or other positioning techniques), to enhance location accuracy. Examples of combined DL-AOD and RTT 1330 positioning techniques are illustrated in FIG. 13.

E-CID positioning techniques may be based on radio resource management (RRM) measurements. In E-CID, a UE may obtain or report a serving cell ID, a timing advance (TA), identifiers of one or more detected neighbor TRPs, estimated timing of one or more detected neighbor TRPs, or a signal strength measurement of one or more detected neighbor TRPs. A positioning device (e.g., an LFM, SLP, UE, or another device) may utilize the serving cell ID, TA, identifiers, estimated timing, or signal strength measurements with one or more established locations of one or more TRPs to estimate the location of the UE.

In some approaches, a positioning device (e.g., location server, LMF, SLP, or another device) may provide assistance data to the UE. Assistance data is data to assist with one or more positioning operations (e.g., to detect one or more neighboring TRPs or to receive reference signaling). For instance, the assistance data may indicate IDs of the TRPs (e.g., IDs of one or more cells or TRPs corresponding to a network node) from which reference signals may be measured. In some examples, a positioning device may transmit assistance data or other information indicating one or more reference signal configuration parameters. The reference signal configuration parameter(s) may include or indicate a quantity of consecutive slots including PRS, a periodicity of consecutive slots including PRS, a muting sequence, a frequency hopping sequence, a reference signal identifier, a reference signal bandwidth, or one or more other parameters applicable to a positioning technique or procedure. Additionally, or alternatively, the assistance data may be sent from one or more TRPs (e.g., in periodically broadcasted overhead messages, a scheduled message, a unicast message, or a multicast message, among other examples). In some examples, a UE may be able to detect one or more neighboring TRPs (e.g., network entities) without the use of assistance data.

For OTDOA positioning techniques or DL-TDOA positioning techniques, the assistance data may indicate an expected RSTD value and an associated uncertainty or search window around the expected RSTD. For example, an expected RSTD value may have an associated uncertainty or search window with a range of ±500 microseconds (μs). In another example, when any of the resources used for the positioning measurement(s) are in frequency range 1 (FR1), an expected RSTD value may have an associated uncertainty or search window with a range of ±32 μs. In another example, when all of the resources used for the positioning measurement(s) are in frequency range 2 (FR2), an expected RSTD value may have an associated uncertainty or search window with a range of ±8 μs.

In some examples, a location may be referred to as a position estimate, location estimate, position, position fix, or fix, among other examples. A location may be geodetic and include coordinates (e.g., latitude, longitude, or altitude) or may be civic and include a street address, postal address, or another description of a location. In some aspects, a location may be defined relative to another location or may be defined in absolute terms (e.g., latitude, longitude, or altitude). A location may include an indication of error or uncertainty (e.g., by including an area or volume within which the location may be included with a specified or default level of confidence).

Various examples of sidelink positioning techniques are illustrated in FIG. 13. Sidelink positioning techniques may include positioning techniques that are based on sidelink communication (e.g., based exclusively on sidelink communication or based on sidelink communication jointly with other communication(s), such as Uu interface communication).

A first example of sidelink positioning 1335 is illustrated in FIG. 13. In the first example of sidelink positioning 1335, at least one peer UE with an established location may improve location estimation (e.g., Uu-based positioning, multi-cell RTT, DL-TDOA, or UL-TDOA, among other examples) for a target UE by providing an additional anchor (e.g., sidelink RTT (SL-RTT)).

A second example of sidelink positioning 1340 is illustrated in FIG. 13. In the second example of sidelink positioning 1340, different types (e.g., categories, classes, or capabilities) of UEs may be utilized. For example, first UEs and a second UE may be utilized. Relative to the second UE, the first UEs may have one or more increased capabilities, such as one or more additional sensors, a faster processor, greater memory capacity, one or more additional antenna elements, a higher transmit power capability, access to one or more additional frequency bands, or any combination thereof. In some aspects, the second UE may be a reduced capacity or “RedCap” UE. The second UE may be assisted by the first UEs to determine the location of the second UE. For instance, sidelink-based positioning or ranging procedures may be performed with the first UEs, which may enhance the location accuracy of the second UE.

A third example of sidelink positioning 1345 is illustrated in FIG. 13. The third example of sidelink positioning 1345 may be performed via one or more sidelink connections (e.g., via sidelink connections exclusively or jointly with one or more Uu-based connections). In the third example of sidelink positioning 1345, the UEs may perform peer-to-peer (P2P) positioning or ranging. Sidelink positioning may be helpful for out-of-coverage or public safety scenarios. For instance, the UEs may be out of coverage of a network and may determine a location or a relative distance and a relative position among the UEs using sidelink positioning techniques. In some examples, sidelink positioning may be performed by UEs in public safety scenarios (e.g., for police, firefighters, search-and-rescue, or paramedics, among other examples).

A fourth example of sidelink positioning 1350 is illustrated in FIG. 13. The fourth example of sidelink positioning 1350 may be performed via one or more sidelink connections (e.g., via sidelink connections exclusively or jointly with one or more Uu-based connections). In the fourth example of sidelink positioning 1350, one or more of the UEs may determine a location or a relative distance and a relative position using sidelink positioning techniques, such as SL-RTT. For instance, one or more of the UEs may be out of coverage of a network and may determine a location or a relative distance and a relative position among the UEs using sidelink positioning techniques.

An example of relay positioning 1355 is illustrated in FIG. 13. In the example of relay positioning 1355, a relay UE (e.g., with an established location) may participate in the location estimation of a remote UE (without performing uplink reference signal transmission over the Uu interface, for instance). For example, the relay UE may receive a downlink PRS from a TRP and may relay an SL-PRS to the remote UE. In some cases, the remote UE may also receive another downlink PRS from the TRP. A positioning device (e.g., location server, LMF, SLP, UE, or other device) may utilize a downlink PRS measurement and an SL-PRS measurement with the established location of the relay UE to estimate the location of the remote UE.

An example of joint positioning 1360 is illustrated in FIG. 13. In the example of joint positioning 1360, multiple peer UEs (without established locations, for instance) may be located. In some approaches, multiple peer UEs may be jointly located in NLOS conditions by utilizing one or more constraints from one or more peer (e.g., neighboring or nearby) UEs. As illustrated in FIG. 13, RTT or TDOA techniques may be performed between TRP1 and each of the peer UEs, may be performed between TRP2 and each of the peer UEs, and may be performed between the peer UEs. In some examples, one or more of the peer UEs may report measurements from the RTT or TDOA technique(s) to a positioning device. The positioning device (e.g., location server, LMF, SLP, UE, or other device) may utilize the measurements from the RTT or TDOA technique(s) to estimate the locations of the peer UEs.

In some examples, the wireless communications systems 1300 may utilize some of the techniques of the present disclosure. For example, one or more UEs may be wireless devices that are low-power, low-cost, or both and perform one or more operations for one or more positioning procedures. In some cases, to perform the one or more positioning operations, the techniques of the present disclosure may describe UEs obtaining a channel estimation by pre-processing a reference signal prior to performing a transformation procedure such to prevent utilization of a decimation procedure and ensuring relatively minimal to no loss in performance and accuracy of the channel estimate. Further, the techniques of the present disclosure may ensure that the positioning procedures described and illustrated herein are relatively more power efficient and have relatively less latency, power consumption, and cost to improve the accuracy and efficiency of the positioning procedures within the wireless communications systems 1300.

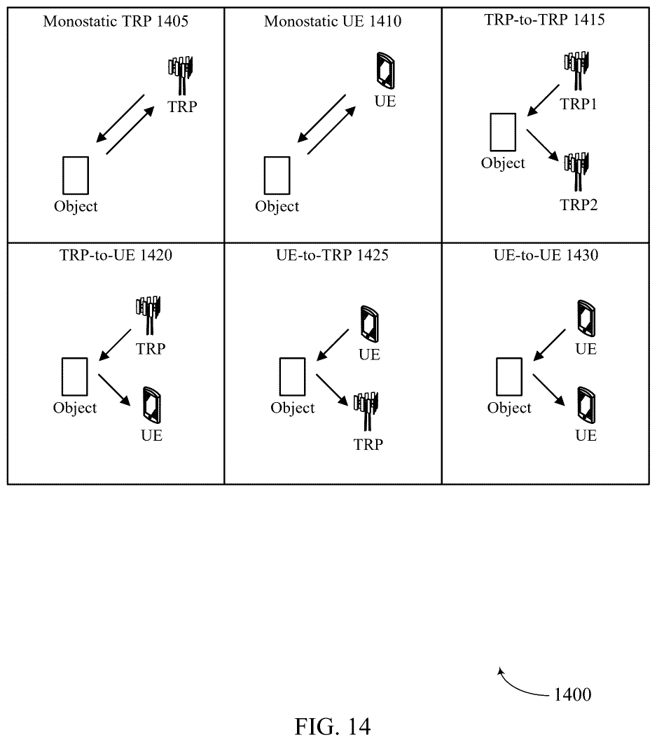

FIG. 14 shows examples of sensing modes 1400 that support channel estimation based on time domain signals in accordance with one or more aspects of the present disclosure. Various sensing modes are illustrated in the context of one or more devices (e.g., TRPs and UEs). While TRPs are illustrated in FIG. 14, a TRP may instead be a base station (e.g., gNB) in some examples. The objects illustrated in FIG. 14 may be devices (e.g., UEs, automated guided vehicles (AGVs), or vehicles, among other examples) or passive objects (e.g., roads, signs, barriers, or rocks, among other examples).

One or more sensing operations may be performed in accordance with one or more of the techniques described herein. Sensing operations may include monostatic sensing (e.g., radar-like sensing, where a sensing transmitter and a sensing receiver may be co-located in the same entity) or bistatic sensing (e.g., where a sensing receiver and sensing transmitter are located in different entities). Multi-static sensing may be performed in some examples, where multiple sensing transmitters or receivers may be utilized.

In some approaches, one or more reflections of a sensing signal sent from a sensing transmitter may be received by a sensing receiver and processed to determine one or more characteristics of the sensed object or an environment (e.g., location). In sensing operations, one or more sensing signal reflections may be received. The sensing signal reflections may be processed locally (e.g., in a device that received the sensing signal reflections) or may be communicated to another device for processing. For instance, a device may execute one or more AI/ML models to determine a position of the object based on the sensing signal reflections.

An example of monostatic TRP sensing 1405 is given in FIG. 14. For example, a TRP (e.g., gNB) may transmit a signal and receive a signal reflection from the object.

An example of monostatic UE sensing 1410 is given in FIG. 14. For example, a UE may transmit a signal and receive a signal reflection from the object.

An example of bistatic TRP-to-TRP sensing 1415 is given in FIG. 14. For example, a first TRP (e.g., a first gNB) may transmit a signal, and a second TRP may receive a signal reflection from the object.

An example of bistatic TRP-to-UE sensing 1420 is given in FIG. 14. For example, a TRP (e.g., a gNB) may transmit a signal, and a UE may receive a signal reflection from the object.

An example of bistatic UE-to-TRP sensing 1425 is given in FIG. 14. For example, a UE may transmit a signal, and a TRP may receive a signal reflection from the object.

An example of bistatic UE-to-UE sensing 1430 is given in FIG. 14. For example, a first UE may transmit a signal, and a second UE may receive a signal reflection from the object.

In some aspects, one or more of the AI/ML-based positioning or sensing procedures or communications (e.g., capability information, request information, indications, or meaning information, among other examples) described herein may be utilized for one or more sensing use cases. For instance, sensing may be performed to determine a position or motion of an object (e.g., a wireless device or other object). Examples of sensing use cases may include one or more of transportation, unmanned aerial vehicles (UAVs), smart cities, smart homes, smart factories, or health monitoring. For instance, a transportation use case may include intrusion detection on a highway, sensing assisted automotive maneuvering or navigation, smart parking, or other assistance, among other examples. A UAV use case may include UAV flight trajectory tracing or sensing for UAV intrusion detection, among other examples. A smart city use case may include rainfall monitoring, tourist spot traffic management, flooding awareness, weather forecasting, or public safety search and rescue, among other examples. A smart home use case may include intruder detection in a smart home, gesture recognition, or extended reality (XR) streaming, among other examples. A smart factory use case may include AGV detection and tracking in factories or inventory tracking, among other examples. A health monitoring use case may include monitoring vital signs and health related measures, sleep monitoring, or health monitoring, among other examples. Examples of sensing modes that may be employed in some examples of the techniques may be implemented in the wireless communications system described with reference to FIGS. 4 through 6.

In some examples, one or more of the AI/ML models described herein may correspond to one or more sensing key performance indicators (KPIs) (with equivalent A-AI/ML sensing or D-AI/ML sensing). Some examples of sensing KPIs may include an accuracy of positioning (e.g., horizontal or vertical), an accuracy of range or cross-range of target, an accuracy of AOA of a target (e.g., azimuth or elevation), an accuracy of velocity (e.g., horizontal or vertical), a sensing range or cross-range resolutions, a sensing velocity resolution, a sensing angle resolution, a sensing latency, a sensing refreshing rate, a receiver operating characteristics (ROC) (e.g., misdetection or false alarm probabilities), a confidence interval or level of sensing, or target discrimination.

Some examples of the techniques described herein may utilize one or more terms relating to sensing. Sensing data may include data derived from one or more radio signals impacted (e.g., reflected, refracted, diffracted) by an object or environment of interest for sensing purposes, and optionally processed. 5G Wireless sensing (5GS) may be a feature providing one or more capabilities to obtain information about characteristics of the environment or objects within the environment (e.g., shape, size, orientation, speed, location, distances or relative motion between objects, among other examples) using radio frequency signals. Non-3GPP sensing data may be data provided by non-3GPP sensors (e.g., video, LIDAR, sonar) about an object or environment of interest for sensing purposes. Sensing assistance information may be information that is provided to a wireless system from a third-party and may be used to support the derivation of a sensing result. Examples of sensing assistance information may include map information, area information, a UE ID attached to or in the proximity of the sensing target, UE position information, or UE velocity information, among other examples.

Sensing contextual information may be information that is exposed with the sensing results by a wireless system to a third-party which provides context to the conditions under which the sensing results were derived. Examples may include map information, area information, time of capture, UE location, or an identifier. This contextual information may be demanded in scenarios where the sensing result is to be combined with data from other sources outside the 5GS. A sensing group may be a set of sensing transmitters and sensing receivers whose location is known and whose sensing data can be collected synchronously. A sensing receiver may be an entity that receives a sensing signal which a sensing service may use in operation. A sensing receiver may be part of a RAN node or a UE. A sensing receiver may be located in the same or different entity as the sensing transmitter. A sensing result may be processed sensing data requested by a service consumer. Sensing signals may be transmissions on a radio interface that can be used for sensing purposes. Some approaches may refer to NR radio frequency signals which, in some cases.

A sensing transmitter may be an entity that sends out a sensing signal which the sensing service will use in its operation. A sensing transmitter may be part of a RAN node or a UE. A sensing transmitter may be located in the same or different entity as the sensing receiver. A target sensing service area may be a cartesian location area to be sensed by deriving characteristics of the environment or objects within the environment with a sensing service quality from the impacted (e.g., reflected, refracted, diffracted) radio signals. This may include indoor or outdoor environments.

RF sensing may extend positioning capabilities to one or more applications. Factors affecting sensing performance may include RCS, mobility, or clutter/scattering patterns. One or more channel modeling aspects may be utilized to support object detection or tracking. A modeling framework may be capable of detecting or tracking one or more objects and to enable them to be distinguished from unintended objects. Some examples of objects may include UAVs, humans (indoors or outdoors), automotive vehicles (at least outdoors), automated guided vehicles (e.g., in indoor factories), or objects creating hazards on roads/railways (e.g., with a minimum size dependent on frequency). In some examples, one or more frequencies from 0.5 to 52.6 GHz may be utilized, with scalability to 100 GHz.

For one or more use cases, sensing modes and frequencies, deployment scenarios may be identified corresponding to one or more use cases. Channel modeling may be utilized for sensing. One or more measurements may be utilized for modeling of sensing targets or a background environment, including, for example, radar cross-section (RCS), mobility, clutter/scattering patterns, or spatial reliability.

In some examples, a sensing data signal processing flow may be performed from Analog-to-Digital Converter (ADC) samples to progressively higher-level data representations. From low levels to high levels, the data types may include raw data, a range-angle-Doppler (RAD) tensor, a point cloud, or grid map. Learning-based frameworks may be utilized, which may support the encoding and decoding of different representation types, and additional quantization can be adopted to reduced data size. For integrated sensing and communication, for instance, one or more types of data representations may be utilized, which may include data quantization, range fast Fourier transform (FFT), Doppler FFT, angle FFT, RAD tensor, point cloud, voxel grids, neural network (NN)-based representations, or parametric objects. In some examples, an ADC signal may be utilized to obtain one or more of the types of representations. In some aspects, a deep learning framework or quantization may be applied for one or more (e.g., all) types of representations. One or more types of representations may be provided to an SnMF for one or more sensing operations.

One or more of the data representations are described as follows. Data quantization: at a relatively low (e.g., lowest) level, sampling and quantization of the sensing signal may be initial operations. To reduce the volume of data that needs to be processed, various techniques may be utilized. Some approaches, such as compressed sensing, may exploit the sparsity of the signal to acquire the signal at a lower sampling rate. Other approaches may use relatively low-bit quantization to reduce complexity and power consumption at the TRP. In particular, the power consumption of ADCs in hybrid architectures may grow exponentially to the quantity of quantization levels, thus elevating the significance of ADC quantization. In some cases, sampling may be performed with one bit per sample, significantly reducing the data volume to be transmitted by the TRP. Data quantization may be combined with other representations, such as RAD tensors or point clouds, among other examples. Data quantization may be used as the format of data to be exchanged in a case of signal-level fusion where the sensing data is sent directly to a fusion center without performing any further local processing.

RAD tensors: range-angle and range-Doppler maps may be data representations in radar signal processing. The maps may provide a structured way to visualize or analyze spatial or velocity information of detected targets. In the context of integrated sensing and communication, the maps may be useful for tasks like target detection, localization, and tracking.

Point clouds: point clouds may be versatile data representations that may be utilized in various sensing applications, including radar, LIDAR, or computer vision. In the context of integrated sensing and communication, point clouds may provide a spatial representation of multiple targets by capturing discrete points in a three-dimensional space. Each point in the cloud may contain information about the target's range, velocity, azimuth angle, or elevation angle.

Voxel grids: voxel grids may be another form of data representation where the 3D space is divided into a grid of volumetric pixels (voxels). Each voxel can store information such as occupancy, intensity, or other attributes. Voxel grids may be useful for representing an environment in autonomous driving and robotics applications. Voxel grids may provide a structured representation that may be processed by algorithms but can be memory intensive.

Deep Learning-Based Representations: advancements in deep learning may lead to the development of various data representations. For instance, radar data may be transformed into images or tensors that are fed into convolutional neural networks (CNNs) for tasks such as object detection or classification. The representations may leverage deep learning to extract high-level features from raw data, which may improve the accuracy or robustness of sensing systems. Variational auto-encoders (VAE) may be utilized, which may project input data into a distribution over the latent space. In particular, the following forms of deep learning representations may be utilized: embeddings, feature vectors (e.g., outputs of feature extraction layers), or layer weights.

Parametric object representations: by performing object segmentation over point clouds, scene information may be conveyed with relatively less data. This operation may involve: (i) employing clustering algorithms to separate the point cloud into groups that correspond to different environment objects; and (ii) unifying the points of each group to a compact representation, therefore unveiling the shape of each object. To describe shapes of 3D objects, multiple approaches may be taken, such as polygon representations (represented as the convex hulls of each point cloud group), wireframes (interconnected sets of edges), or general parametric shapes, where each shape is represented by the set of its geometric parameters (e.g., center and radius for 3D balls). While accurately representing real objects with geometrical shapes may present challenges, such representation may be utilized such that relatively few bytes of information may be transmitted to describe a scene.

In some examples, the wireless communications systems 1300 may utilize some of the techniques of the present disclosure. For example, one or more UEs may be wireless devices that are low-power, low-cost, or both and perform one or more operations for one or more sensing procedures in accordance with the techniques of the present disclosure. In some cases, to perform the one or more sensing operations, the techniques of the present disclosure may describe UEs obtaining a channel estimation by pre-processing a reference signal prior to performing a transformation procedure such to prevent utilization of a decimation procedure and ensuring relatively minimal to no loss in performance and accuracy of the channel estimate. Further, the techniques of the present disclosure may ensure that the sensing procedures described and illustrated herein are relatively more power efficient and have relatively less latency, power consumption, and cost to improve the accuracy and efficiency of the sensing procedures described via the sensing modes 1400.

The following provides an overview of aspects of the present disclosure:

Aspect 1: A method for wireless communications by a first wireless device, comprising: receiving a reference signal from a second wireless device via a communication channel between the first wireless device and the second wireless device; determining, within a time domain, a second plurality of samples that is based at least in part on a first plurality of samples of the reference signal, the second plurality of samples comprising a combination of samples, at an interval in the time domain, of the first plurality of samples, wherein a second quantity of the second plurality of samples is less than a first quantity of the first plurality of samples; transforming the second plurality of samples from the time domain to a frequency domain based at least in part on the second quantity of the second plurality of samples; and performing one or more operations utilizing a channel estimation that is based at least in part on the second plurality of samples transformed to the frequency domain.

Aspect 2: The method of aspect 1, further comprising: estimating a difference between the second plurality of samples in the frequency domain and reference signal information to obtain the channel estimation of the communication channel between the first wireless device and the second wireless device, wherein performing the one or more operations utilizing the channel estimation is based at least in part on obtaining the channel estimation.

Aspect 3: The method of any of aspects 1 through 2, wherein transforming the second plurality of samples comprises: performing an FFT on the second plurality of samples to transform the second plurality of samples from the time domain to the frequency domain.

Aspect 4: The method of aspect 3, wherein the fast Fourier transform is an N-point FFT that is based at least in part on the interval in the time domain.

Aspect 5: The method of aspect 4, further comprising: communicating an indication of a factor with the second wireless device, wherein the reference signal is based on an IFFT at the second wireless device, wherein a size of the N-point FFT is an integer divisor of a size of the IFFT that is based on the factor.

Aspect 6: The method of any of aspects 1 through 5, wherein the second quantity of the second plurality of samples is based at least in part on the interval in the time domain.

Aspect 7: The method of any of aspects 1 through 6, wherein the reference signal is associated with a multi-stream communication.

Aspect 8: The method of any of aspects 1 through 7, wherein determining the second plurality of samples is based at least in part on a processing procedure before transforming the second plurality of samples from the time domain to the frequency domain.

Aspect 9: The method of any of aspects 1 through 8, wherein the one or more operations utilizing the channel estimation are associated with channel positioning procedures, channel sensing procedures, channel sounding procedures, or any combination thereof.

Aspect 10: A first wireless device for wireless communications, comprising one or more transceivers, one or more memory, and one or more processors electronically coupled with the one or more memory and the one or more transceivers, the one or more processors configured to perform a method of any of aspects 1 through 9.

Aspect 11: A first wireless device for wireless communications, comprising at least one means for performing a method of any of aspects 1 through 9.

Aspect 12: A non-transitory computer-readable medium storing code for wireless communications, the code comprising instructions executable by one or more processors to perform a method of any of aspects 1 through 9.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of′ or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device for wireless communications, comprising:
one or more transceivers;
one or more memory; and
one or more processors electronically coupled with the one or more memory and the one or more transceivers, the one or more processors configured to:
receive a reference signal from a second wireless device via a communication channel between the first wireless device and the second wireless device;
determine, within a time domain, a second plurality of samples that is based at least in part on a first plurality of samples of the reference signal, the second plurality of samples comprising a combination of samples, at an interval in the time domain, of the first plurality of samples, wherein a second quantity of the second plurality of samples is less than a first quantity of the first plurality of samples;
transform the second plurality of samples from the time domain to a frequency domain based at least in part on the second quantity of the second plurality of samples; and
perform one or more operations utilizing a channel estimation that is based at least in part on the second plurality of samples transformed to the frequency domain.

2. The first wireless device of claim 1, wherein the one or more processors are further configured to:
estimate a difference between the second plurality of samples in the frequency domain and reference signal information to obtain the channel estimation of the communication channel between the first wireless device and the second wireless device, wherein performing the one or more operations utilizing the channel estimation is based at least in part on obtaining the channel estimation.

3. The first wireless device of claim 1, wherein, to transform the second plurality of samples, the one or more processors are configured to:
perform a fast Fourier transform (FFT) on the second plurality of samples to transform the second plurality of samples from the time domain to the frequency domain.

4. The first wireless device of claim 3, wherein the fast Fourier transform is an N-point FFT that is based at least in part on the interval in the time domain.

5. The first wireless device of claim 4, wherein the one or more processors are further configured to:
communicate an indication of a factor with the second wireless device, wherein the reference signal is based on an inverse fast Fourier transform (IFFT) at the second wireless device, wherein a size of the N-point FFT is an integer divisor of a size of the IFFT that is based on the factor.

6. The first wireless device of claim 1, wherein the second quantity of the second plurality of samples is based at least in part on the interval in the time domain.

7. The first wireless device of claim 1, wherein the reference signal is associated with a multi-stream communication.

8. The first wireless device of claim 1, wherein determination of the second plurality of samples is based at least in part on a processing procedure before transforming the second plurality of samples from the time domain to the frequency domain.

9. The first wireless device of claim 1, wherein the one or more operations utilizing the channel estimation are associated with one or more positioning procedures, one or more sensing procedures, one or more channel sounding procedures, or any combination thereof.

10. A method for wireless communications by a first wireless device, comprising:
receiving a reference signal from a second wireless device via a communication channel between the first wireless device and the second wireless device;
determining, within a time domain, a second plurality of samples that is based at least in part on a first plurality of samples of the reference signal, the second plurality of samples comprising a combination of samples, at an interval in the time domain, of the first plurality of samples, wherein a second quantity of the second plurality of samples is less than a first quantity of the first plurality of samples;
transforming the second plurality of samples from the time domain to a frequency domain based at least in part on the second quantity of the second plurality of samples; and
performing one or more operations utilizing a channel estimation that is based at least in part on the second plurality of samples transformed to the frequency domain.

11. The method of claim 10, further comprising:
estimating a difference between the second plurality of samples in the frequency domain and reference signal information to obtain the channel estimation of the communication channel between the first wireless device and the second wireless device, wherein performing the one or more operations utilizing the channel estimation is based at least in part on obtaining the channel estimation.

12. The method of claim 10, wherein transforming the second plurality of samples comprises:
performing a fast Fourier transform (FFT) on the second plurality of samples to transform the second plurality of samples from the time domain to the frequency domain.

13. The method of claim 12, wherein the fast Fourier transform is an N-point FFT that is based at least in part on the interval in the time domain.

14. The method of claim 13, further comprising:
communicating an indication of a factor with the second wireless device, wherein the reference signal is based on an inverse fast Fourier transform (IFFT) at the second wireless device, wherein a size of the N-point FFT is an integer divisor of a size of the IFFT that is based on the factor.

15. The method of claim 10, wherein the one or more operations utilizing the channel estimation are associated with one or more positioning procedures, one or more sensing procedures, one or more channel sounding procedures, or any combination thereof.

16. A non-transitory computer-readable medium storing code for wireless communications, the code comprising instructions executable by one or more processors to:
receive a reference signal from a second wireless device via a communication channel between a first wireless device and the second wireless device;
determine, within a time domain, a second plurality of samples that is based at least in part on a first plurality of samples of the reference signal, the second plurality of samples comprising a combination of samples, at an interval in the time domain, of the first plurality of samples, wherein a second quantity of the second plurality of samples is less than a first quantity of the first plurality of samples;
transform the second plurality of samples from the time domain to a frequency domain based at least in part on the second quantity of the second plurality of samples; and
perform one or more operations utilizing a channel estimation that is based at least in part on the second plurality of samples transformed to the frequency domain.

17. The non-transitory computer-readable medium of claim 16, wherein the instructions are further executable by the one or more processors to:
estimate a difference between the second plurality of samples in the frequency domain and reference signal information to obtain the channel estimation of the communication channel between the first wireless device and the second wireless device, wherein performing the one or more operations utilizing the channel estimation is based at least in part on obtaining the channel estimation.

18. The non-transitory computer-readable medium of claim 16, wherein the instructions to transform the second plurality of samples are executable by the one or more processors to:
perform a fast Fourier transform (FFT) on the second plurality of samples to transform the second plurality of samples from the time domain to the frequency domain.

19. The non-transitory computer-readable medium of claim 18, wherein the fast Fourier transform is an N-point FFT that is based at least in part on the interval in the time domain.

20. The non-transitory computer-readable medium of claim 19, wherein the instructions are further executable by the one or more processors to:
communicate an indication of a factor with the second wireless device, wherein the reference signal is based on an inverse fast Fourier transform (IFFT) at the second wireless device, wherein a size of the N-point FFT is an integer divisor of a size of the IFFT that is based on the factor.
